(19) United States
(12) Patent Application Publication
(10) Pub. No.: US 2012/0013811 A1
(43) Pub. Date: Jan. 19, 2012

(54) LIGHTING DEVICE, DISPLAY DEVICE AND TELEVISION RECEIVER

(75) Inventor: Takaharu Shimizu, Osaka-shi (JP)

(73) Assignee: SHARP KABUSHIKI KAISHA, Osaka-shi, Osaka (JP)

(21) Appl. No.: 13/258,053

(22) PCT Filed: Dec. 21, 2009
(86) PCT No.: PCT/JP2009/071213

§ 371 Date: Sep. 21, 2011

(30) Foreign Application Priority Data
Apr. 3, 2009 (JP) 2009-091438

(51) Int. Cl. H04N 5/66; G02F 1/13357; F21V 7/04

(52) U.S. Cl. 348/739; 362/609; 349/61; 348/E05.133

(57) ABSTRACT

A backlight unit 12 included in a liquid crystal display device 10 includes an LED 16, a light guide plate 18, a first light scattering structure 23, and a light reflector 24. The LED 16 is a light source. The light guide plate 18 has alight entrance surface 18b through which light enters and a light exit surface 18c through which the light exits. The light entrance surface 18b is opposite the LED 16. The light exit surface 18c is parallel to the light entrance surface 18b. The first light scattering structure 23 is provided at the light entrance surface 18b and configured to scatter the light. The light reflector 24 is provided at the light exit surface 18c and configured to reflect the light.

### TECHNICAL FIELD

The present invention relates to a lighting device, a display device and a television receiver.

### BACKGROUND ART

In recent years, display components in image display devices including television receivers are being shifted from conventional cathode-ray tube display devices to thin display devices in which thin display components such as liquid crystal panels or plasma display panels are used. The thicknesses of image display devices are reduced. Liquid crystal display devices require backlight units separately from liquid crystal panels because the liquid crystal panels do not emit light. The backlight units are classified broadly into two types, direct type and sidelight type, according to mechanisms. An example of sidelight backlight units is disclosed in Patent Document 1. An example of direct backlight units is disclosed in Patent Document 2.

Patent Document 1: Japanese Published Patent Application No. 2006-108045

Patent Document 2: Japanese Published Patent Application No. 2006-286217

### PROBLEM TO BE SOLVED BY THE INVENTION

In a sidelight backlight unit, a sufficient length of an optical path is provided between a point at which light emitted from the light source enters a light guide plate and a point at which the light exits from the light exit surface. Therefore, uneven brightness is less likely to occur. The light in the light guide plate does not exit directly from the light exit surface. The light exits from the light exit surface after being reflected by a reflection sheet arranged on a surface of the light guide plate opposite from the light exit surface. Namely, light use efficiency is not high. As a result, overall brightness tends to be low.

In a direct backlight unit, alight source is arranged directly behind a light guide plate. Light from the light source directly exits from a light guide surface of the light guide plate. Therefore, high brightness can be achieved. In an in-plan brightness distribution at the light exit surface, the brightness tends to be locally high around the light source. Namely, uneven brightness tends to occur. The Patent Document 2 discloses a technology for compensating uneven brightness. A light guide plate has a reflective surface configured to reflect light toward a light source. The reflective surface is provided in an area of a surface of the light guide plate away from the light source. The area overlaps the light source when viewed in plan. When the thickness of the light guide plate is reduced to reduce the thickness of the liquid crystal display device, or when a high-intensity light source is used for increasing the brightness, the uneven brightness may not be sufficiently reduced by the above method.

### DISCLOSURE OF THE PRESENT INVENTION

The present invention was made in view of the foregoing circumstances. An object of the present invention is to properly to achieve high brightness while reducing uneven brightness.

### PROBLEM TO BE SOLVED BY THE INVENTION

The lighting device of the present invention includes a light source, a light guide member, a light scattering structure, and a light reflector. The light guide member has a light entrance surface opposite the light source and a light exit surface parallel to the light entrance surface. Light enters through the light entrance surface and exits through the light exit surface. The light scattering structure is configured to scatter the light and provided at the light entrance surface. The light reflector is configured to reflect the light and provided at the light exit surface.

As described above, the light guide member has the light entrance surface and the light exit surface, which are parallel to each other. Therefore, efficiency of use of the light emitted from the light source is high and thus the intensity of the light exiting from the light exit surface is high. With the above configuration, high brightness can be achieved. However, the brightness on the light exit surface is locally high around the light source tends to be high, that is, uneven brightness tends to occur. In an aspect of the present invention, the light scattering structure is provided at the light entrance surface and the light reflector is provided at the light exit surface. The functions and the effects of the light scattering structure and the light reflector are explained below.

The light emitted from the light source is scattered by the light scattering structure at the light entrance surface. The brightness on the light exit surface around the light source is reduced. When the light inside the light guide member reaches the light exit surface, it is reflected by the light reflector at a rate corresponding to the light reflectivity. Namely, the brightness distribution on the light exit surface can be evened by the light scattering structure and by adjusting the light reflectivity of the light reflector as appropriate.

### BRIEF DESCRIPTION OF THE DRAWINGS

FIG. 1 is an exploded perspective view illustrating a general construction of a television receiver according to the first embodiment of the present invention;

FIG. 2 is an exploded perspective view illustrating general constructions of a liquid crystal panel and a backlight;

FIG. 3 is a cross-sectional view of the liquid crystal display device along the long-side direction thereof;

FIG. 4 is a plan view illustrating layouts of LEDs and light guide plates;

FIG. 5 is a cross-sectional view illustrating cross sections of the LED and the light guide plate along the long-side direction;

FIG. 6 is a plan view illustrating a distribution of light reflectivity at a light exit surface;

FIG. 7 is a chart illustrating variations in light reflectivity at the light exit surface along the X-axis direction;

FIG. 8 is a bottom view illustrating degrees of light scattering at a light entrance surface and at a reflection sheet attached surface;

FIG. 9 is a chart illustrating variations in degree of light scattering at the light entrance surface along the X-axis direction;

FIG. 10 is a chart illustrating variations in degree of light scattering at the reflection sheet attached surface along the X-axis direction;

FIG. 11 is a chart illustrating degrees of light scattering at a light entrance surface by a first light scattering structure according to the first modification of the first embodiment;

FIG. 12 is a cross-sectional view illustrating the first light scattering structure;

FIG. 13 is a bottom view illustrating a distribution of degrees of light scattering at a light entrance surface by a first light scattering structure according to the second modification of the first embodiment;

FIG. 14 is a cross-sectional view illustrating the first light scattering structure;

FIG. 15 is a bottom view illustrating a distribution of degrees of light scattering at a reflection sheet attached surface by the second light scattering structure according to the third modification of the first embodiment;

FIG. 16 is a cross-sectional view illustrating the second light scattering structure;

FIG. 17 is a bottom view illustrating a distribution of degrees of light scattering at a light entrance surface by the second light scattering structure according to the fourth modification of the first embodiment;

FIG. 18 is a cross-sectional view illustrating the second light scattering structure;

FIG. 19 is a plan view illustrating a distribution of light reflectivities at a light exit surface by a light reflector according to the fifth modification of the first embodiment;

FIG. 20 is a chart illustrating variations in light reflectivity at the light exit surface along the X-axis direction;

FIG. 21 is a plan view illustrating a distribution of light reflectivities at the light exit surface by a light reflector according to the sixth modification of the first embodiment;

FIG. 22 is a chart illustrating variations in light reflectivity at the light exit surface along the X-axis direction;

FIG. 23 is a plan view illustrating a distribution of light reflectivities at a light exit surface by a light reflector according to the seventh modification of the first embodiment;

FIG. 24 is a cross-sectional view illustrating the light reflector;

FIG. 25 is a cross-sectional view illustrating a light source unit according to the second embodiment of the present invention;

FIG. 26 is a plan view illustrating a distribution of light reflectivities at a light exit surface;

FIG. 27 is a chart illustrating variations in light reflectivities at the light exit surface along the X-axis direction;

FIG. 28 is a bottom view illustrating a distribution of degrees of light scattering at a light entrance surface and at a reflection sheet attached surface; and

FIG. 29 is a chart illustrating variations in degree of light scattering at the reflection sheet attached surface along the X-axis direction.

### BEST MODE FOR CARRYING OUT THE INVENTION

### First Embodiment

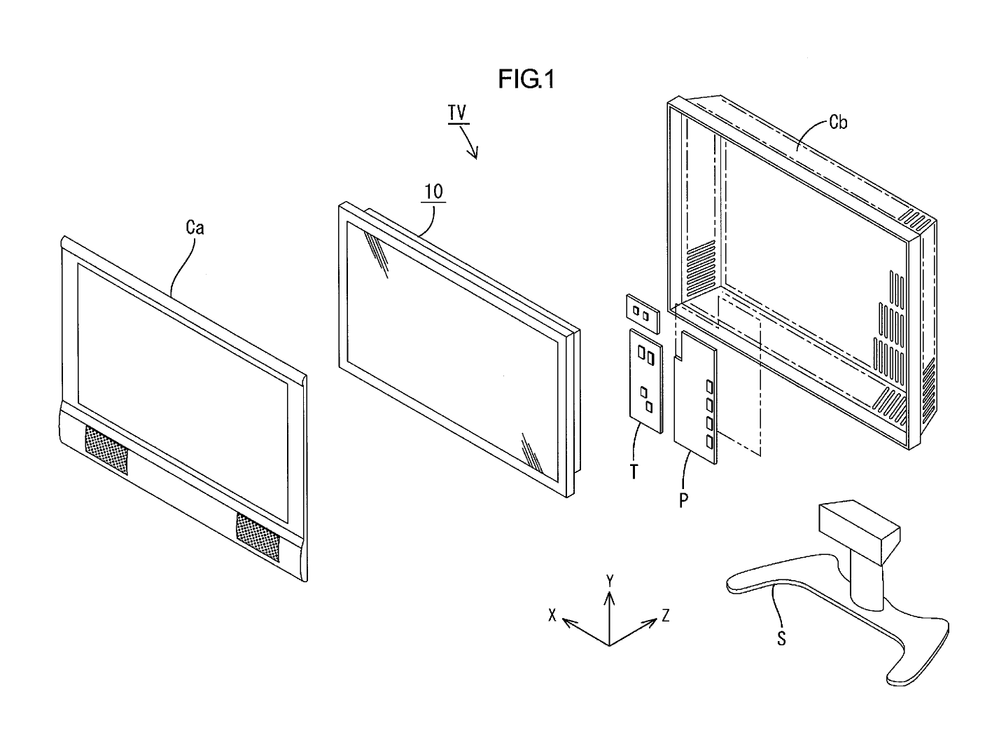

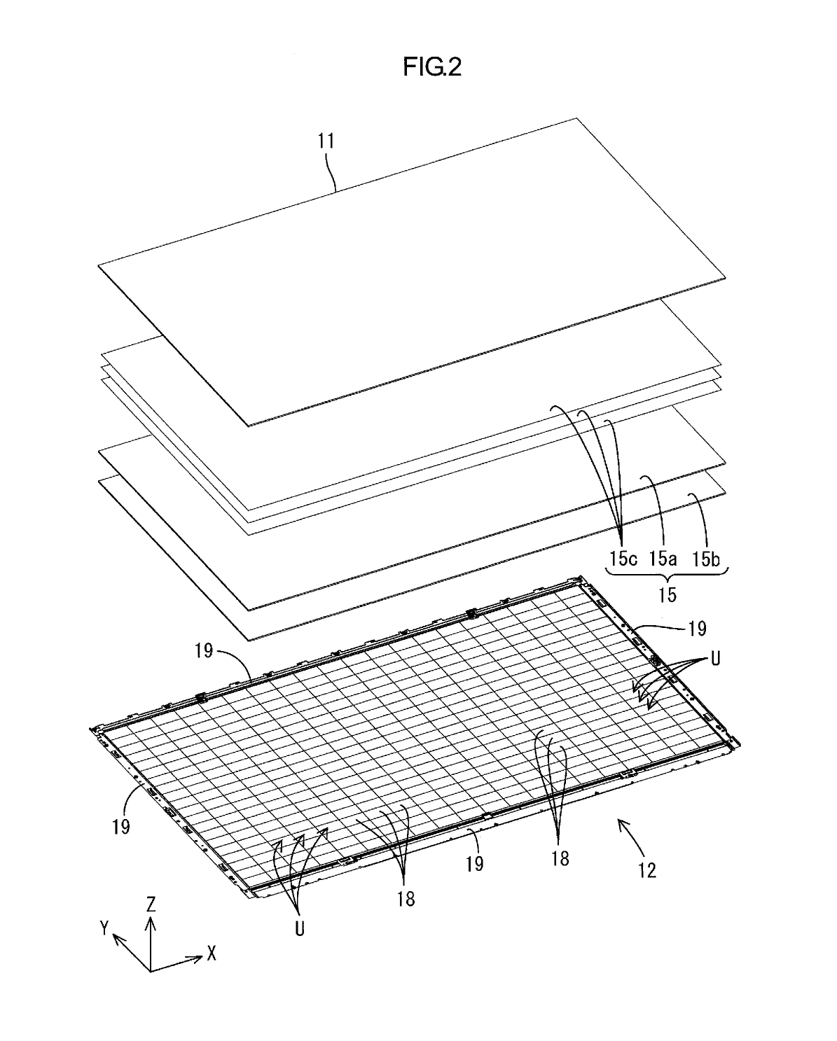

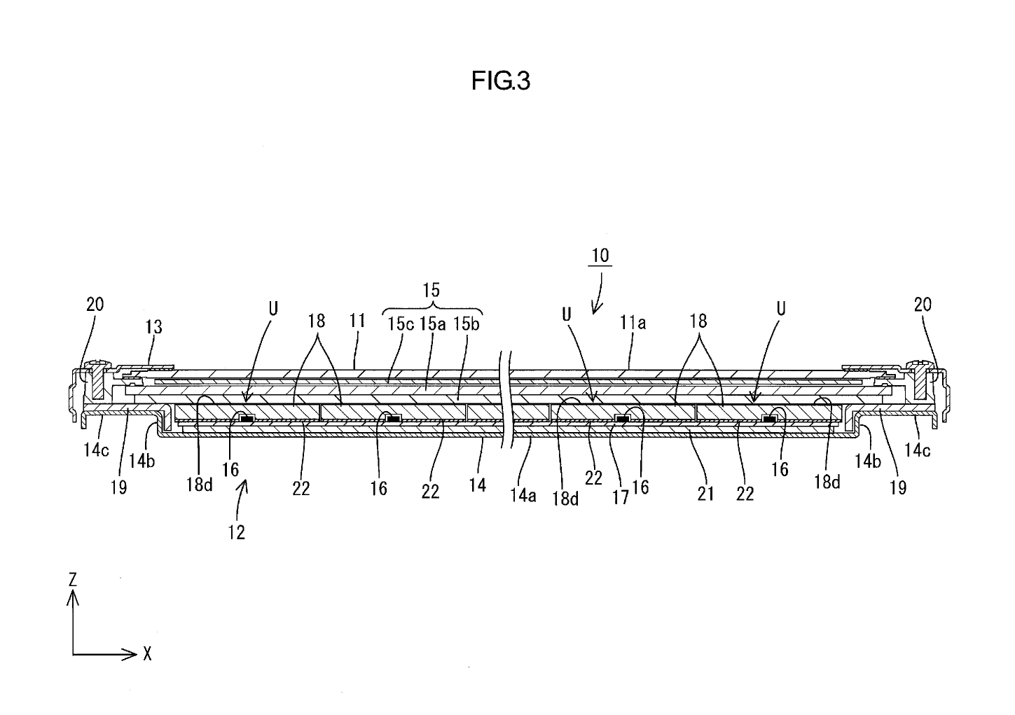

The first embodiment of the present invention will be explained with reference to FIGS. 1 to 10. In this embodiment, a liquid crystal display device 10 will be explained. X-axes, Y-axes and Z-axes are present in some drawings to indicate orientations of the liquid crystal display device 10. In FIGS. 2 and 3, the upper side and the lower side correspond to the front side and the rear side, respectively.

As illustrated in FIG. 1, the television receiver TV includes the liquid crystal display device 10 (a display device), a front cabinet Ca, a rear cabinet Cb, a power source P, and a tuner T. The cabinets Ca and Cb sandwich the liquid crystal display device 10 therebetween. The liquid crystal display device 10 is housed in the cabinets Ca and Cb. The liquid crystal display device 10 is held by a stand S in a vertical position in which a display surface 11a thereof is set along the vertical direction (the Y-axis direction). The liquid crystal display device 10 has a landscape rectangular overall shape. As illustrated in FIG. 2, the liquid crystal display device 10 includes a liquid crystal panel 11, which is a display panel 11, and a backlight unit 12 (a lighting device), which is an external light source. The liquid crystal panel 11 and the backlight unit 12 are held together by a frame-shaped bezel 13.

“The display surface 11a thereof is set along the vertical direction” is not limited to a position in which the display surface 11a is set parallel to the vertical direction. The display surface 11a may be set along a direction closer to the vertical direction than the horizontal direction. For example, the display surface 11a may be 0° to 45° slanted to the vertical direction, preferably 0° to 30° slanted.

Next, the liquid crystal panel 11 and the backlight unit 12 included in the liquid crystal display device 10 will be explained. The liquid crystal panel (a display panel) 11 has a rectangular plan view. The liquid crystal panel 11 includes a pair of glass substrates bonded together with a predetermined gap therebetween and liquid crystals sealed between the substrates. On one of the glass substrates, switching components (e.g., TFTs), pixel electrodes and an alignment film are arranged. The switching components are connected to gate lines and the source lines that are perpendicular to each other. The pixel electrodes are connected to the switching components. On the other glass substrate, color filters including R (red) G (green) B (blue) color sections in predetermined arrangement, a counter electrode and an alignment film are arranged. Polarizing plates are arranged on outer surfaces of the glass substrates, respectively.

Next, the backlight unit 12 will be explained in detail. As illustrated in FIG. 3, the backlight unit 12 includes a chassis 14, an optical member 15, LEDs 16 (Light Emitting Diodes), an LED board 17, and light guide plates 18. The chassis 14 has a box-like overall shape and an opening on the front side (the liquid crystal panel 11 side, the light exit side). The optical member 15 is arranged so as to cover the opening. The LEDs 16 are light sources arranged in the chassis 14. The LEDs 16 are mounted on the LED board 17. The light guide plates 18 configured to guide rays of the light from the LEDs 16 toward the optical member 15. The backlight unit 12 further includes a support member 19, a holddown member 20, and a heatsink 21. The support member 19 supports diffusers 15a and 15b included in the optical member 15 from the rear side. The holddown member 20 holds down the diffusers 15a and 15b from the front side. The heatsink 21 is provided for releasing heat generated according to emission of light by the LEDs 16.

Next, parts of the backlight unit 12 will be explained in detail. The chassis 14 is made of metal. The chassis 14 includes a bottom plate 14a, side plates 14b, and support plates 14c. The bottom plate 14a has a rectangular shape in plan view similar to the liquid crystal panel 11. The side plates 14b rise from the respective outer edges of the bottom plate 14a. The support plates 14c project outward from the distal ends of the respective side plates 14b. An overall shape of the chassis 14 is a shallow box-like shape (or a shallow tray-like shape) with an opening on the front side. The long-side direction and the short-side direction of the bottom plate 14a match the horizontal direction (the X-axis direction) and the vertical direction (the Y-axis direction), respectively. The bezel 13, the support member 19, and the holddown member 20 are placed on the support plates 14c of the chassis 14. The bezel 13, the support member 19, and the holddown member 20 are fixed to the support plates 14c with screws. Mounting structures (not shown) for mounting the LED board 17 and the light guide plates 18 are provided on the bottom plate 14a. Examples of the mounting structures include screw holes in which the screws are inserted and tightened and screw insertion holes through which the screws are passed when the LED board 17 and the light guide plates 18 are mounted with the screws.

The optical member 15 arranged between the liquid crystal panel 11 and the light guide plates 18 includes the diffusers 15a and 15b, and optical sheets 15c. The diffusers 15a and 15b are arranged closer to the light guide plates 18. The optical sheets 15c are arranged closer to the liquid crystal panel 11. Each diffuser 15a or 15b is constructed of a transparent resin base material and a large number of diffusing particles scattered in the base material. The diffuser 15a or 15b is configured to diffuse light that passes therethrough. The diffusers 15a and 15b having the same thickness are layered. Three optical sheets 15c having a sheet-like shape with a thickness smaller than that of the diffusers 15a and 15b are layered. Specifically, the optical sheets 15c include a diffusing sheet, a lens sheet, and a reflection-type polarizing plate layered in this order from the diffuser 15a/15b side (from the rear side). The thicknesses of the diffusers 15a and 15b, and the optical sheets 15c can be set in a range between 100 μm and 3 mm.

Each of the support member 19 and the holddown member 20 has a frame-like shape along the outer edges of the liquid crystal panel 11 or the optical member 15. The support member 19 is directly placed on the support plate 14c of the chassis. The support member 19 supports the outer edges of the rear diffuser 15b of the optical member 15 from the rear side. The holddown member 20 is placed on the support member 19. The holddown member 20 holds down the front diffuser 15a from the front side. Namely, the diffusers 15a and 15b are sandwiched between the support member 19 and the holddown member 20. The holddown member 20 also supports the outer edges of the liquid crystal panel 11 from the rear side. The liquid crystal panel 11 is sandwiched between the holddown member 20 and the bezel 13 that holds the outer edges of the liquid crystal panel 11 from the front side. The bezel 13 is formed in a frame-like shape similar to the support member 19 and the holddown member 20 so as to surround the display area of the liquid crystal panel 11.

The heatsink 21 is made of synthetic resin having high heat conductivity or metal, and formed in a sheet-like shape. The heatsink 21 spreads along the bottom plate 14a of the chassis 14. The heatsink 21 is arranged between the bottom plate 14a of the chassis 14 and the LED board 17.

The LED board 17 is made of synthetic resin with a white surface having high light reflectivity, and placed on the heatsink 21 so as to spread along the bottom plate 14a of the chassis 14. On the LED board 17, metal film wiring patterns are formed and the LEDs 16 are mounted at predetermined locations. An external control board, which is not shown, is connected to the LED board 17. Power necessary for turning on the LEDs 16 is supplied from the control board to the LED board 17. The control board is configured to control the drive of the LEDs 16. Mounting structures, which are not shown, are provided in the LED board 17 for mounting the LED board 17 to the chassis 14. Examples of the mounting structures include screw holes in which the screws are inserted and tightened and screw insertion holes through which the screws are passed when the LED board 17 is mounted with the screws. Such mounting structures are also provided in the light guide plates 18 that will be explained next except for the same configuration.

Next, the LEDs 16 and the light guide plates 18 will be explained. As illustrated in FIGS. 2 and 3, one LED 16 and one light guide plate 18 form a single light source unit U. A plurality of light source units U are two-dimensionally arranged along a display surface 11a (the X-Y plane) in a parallel layout (a planer layout). First, the arrangements of the LEDs 16 and the light guide plates 18 will be explained.

Specifically, the LEDs 16 are surface-mount type LEDs, that is, surface-mounted on the font surface of the LED board 17. The LEDs 16 are arranged in a grid (or a matrix) along the X-axis direction and the Y-axis direction. The light guide plates 18 are arranged between the LED board 17 and the rear diffuser 15b of the light guide member 15. The light guide plates 18 are arranged along the X-axis direction and the Y-axis direction so as to correspond to the respective LEDs 16, that is, arranged in a grid (or a matrix, such as a tile floor). Arrangement intervals of the LEDs 16 on the LED board 17 are substantially equal to arrangement intervals of the light guide plates 18. The light guide plates 18 are arranged such that the adjacent light guide plates 18 with respect to the X-axis direction or the Y-axis direction do not overlap each other in plan view with a predetermined gap (or a clearance) therebetween. Air layers AR are formed in the gaps. Next, configurations of each LED 16 and each light guide plate 18 will be explained.

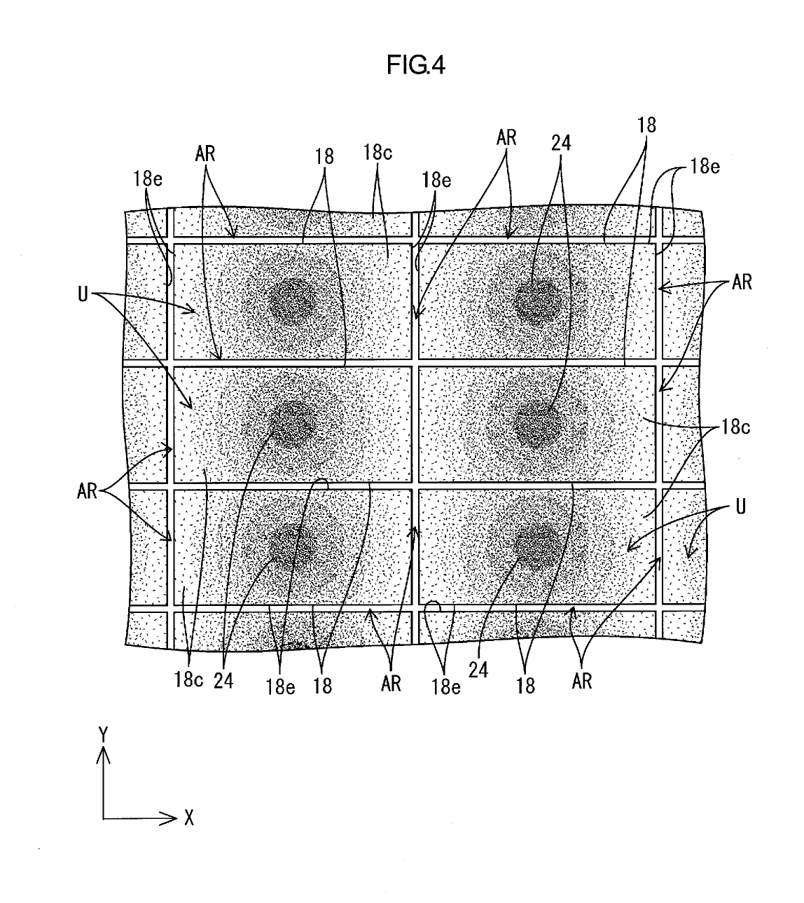

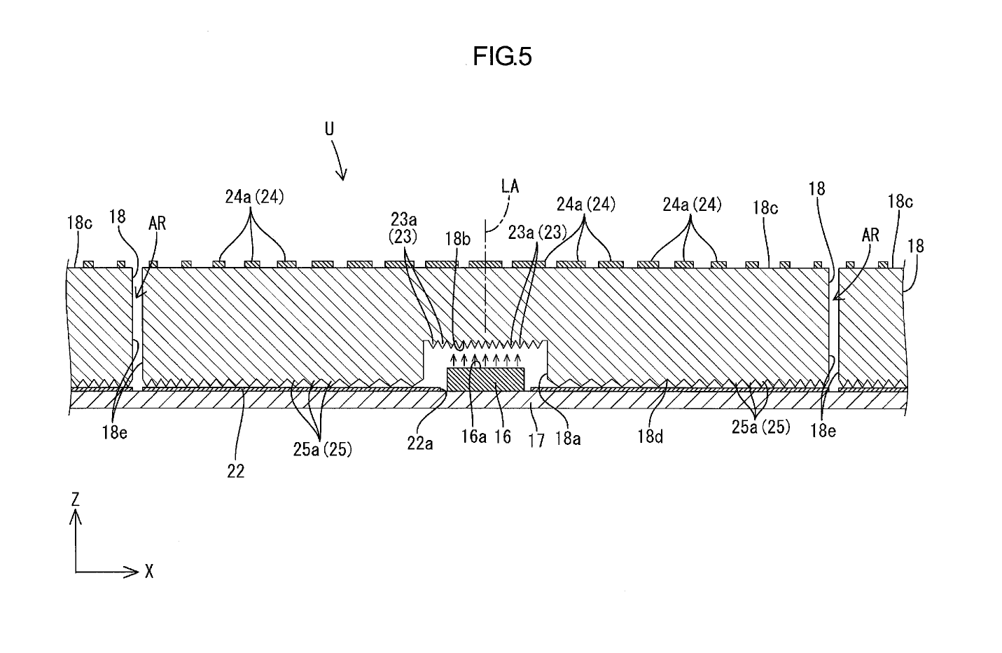

As illustrated in FIGS. 4 and 5, each LED 16 has a block-like overall shape and a rectangular plan-view shape. The LED 16 is arranged with the long side and the short side thereof aligned with the X-axis direction and the Y-axis direction, respectively. As illustrated in FIG. 5, the LED 16 has a block-like overall shape. The LED 16 includes an LED chip disposed on a substrate that is fixed to the LED board 17 and sealed with resin. Three different types of LED chips, wavelengths of main colors of which are different from one another, are used and mounted on respective substrates. Specifically, each LED chip emits light in single color of red (R), green (G), or blue (B). An opposite surface of the LED 16 from the mounting surface that is fixed to the LED board 17 is a light emitting surface 16a, that is, the LED 16 is a top-emitting LED. A light axis LA of the LED 16 is substantially matches the Z-axis direction (corresponding to an arrangement direction of the LED 16 and a light entrance surface 18b, which will be explained later). Moreover, the light axis LA is perpendicular to the display surface 11a of the liquid crystal panel 11 (corresponding to the light entrance surface 18b a light exit surface 18c of the light guide plate 18, which will be explained later). Light that exits from the LED 16 three-dimensionally radiates around the light axis LA within a predetermined angle range. A directivity of the LED 16 is higher than that of a cold cathode tube or other light source. Namely, an angular distribution of light emission shows a tendency that an emission intensity of the LED 16 is significantly high along the light axis LA and sharply decreases as an angle to the light axis LA becomes larger.

The light guide plate 18 is made of substantially transparent (i.e., having high light transmission capability) synthetic resin (e.g. polycarbonate (PC), acrylonitrile styrene copolymer (AS), polystyrene (PS), polymethyl methacrylate (PMMA), polyethylene terephthalate (PET)), a refractive index of which is relatively higher than that of the air. As illustrated in FIGS. 4 and 5, the light guide plate 18 has a plate-like overall shape and a rectangular plan-view shape. The light guide plate 18 is arranged with the long-side direction and the short-side direction thereof aligned with the X-axis direction and the Y-axis direction, respectively.

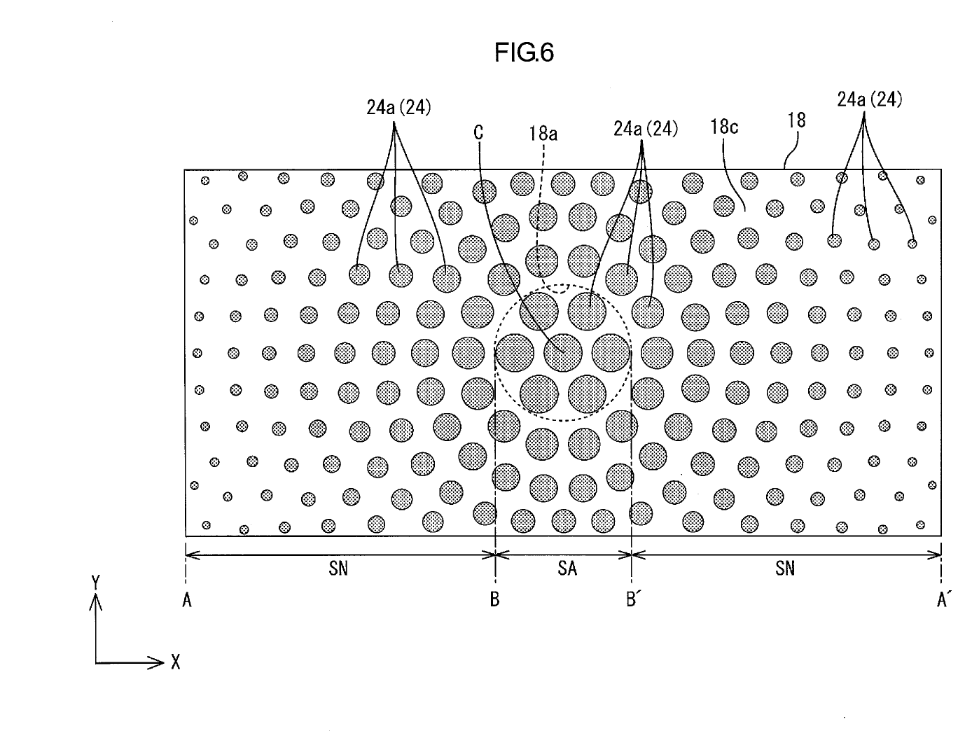

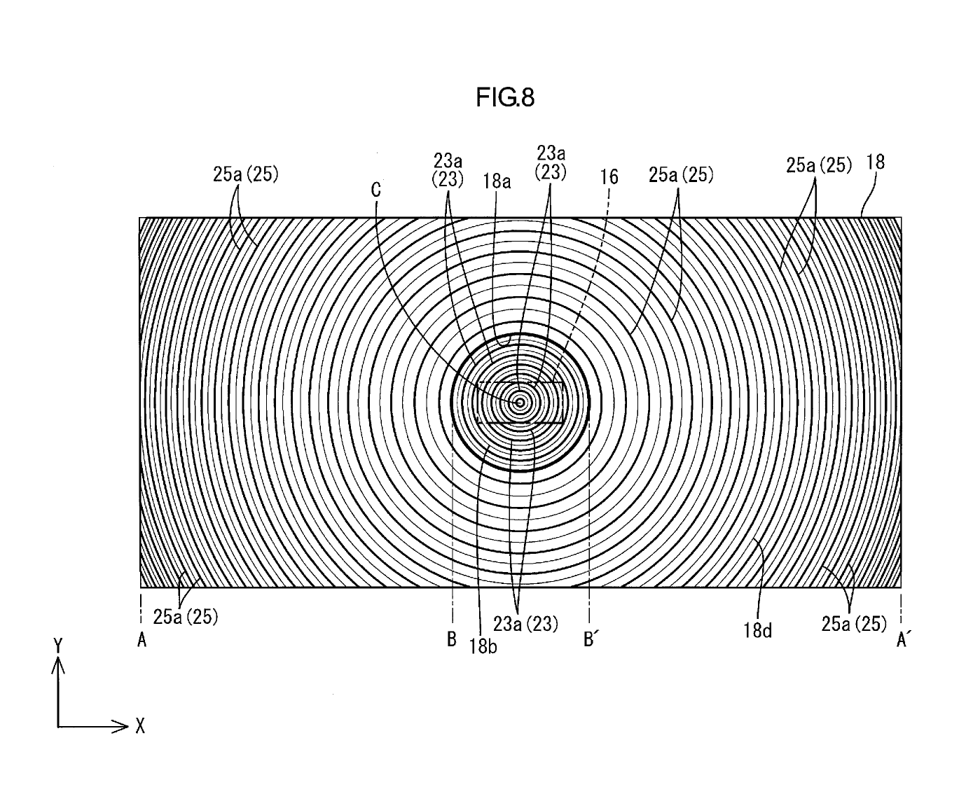

As illustrated in FIG. 5, the light guide plate 18 is arranged between the LED board 17 and the diffuser 15b, and mounted to the LED board 17. The light guide plate 18 covers the LED 16 that is mounted on the LED board 17 from the front side. In other words, the LED 16 is arranged immediately below and opposite the light guide plate 18. The light guide plate 18 has an LED holding recess 18a in the rear surface, that is, the opposed surface thereof to the LED board 17 (the surface opposite from the light exit surface 18c). The LED holding recess 18a is provided for holding the LED 16. The LED holding recess 18a is formed around an X-axis center and a Y-axis center of the light guide plate 18. The X dimension and the Y dimension of the LED holding recess 18a are larger than those of the LED 16, respectively (see FIGS. 6 and 8). The LED 16 is arranged in the LED holding recess 18a such that the outer surface thereof is a predetermined distance away from the bottom of the LED holding recess 18a. When the LED is placed in LED holding recess 18a, the LED 16 is located around the center of the light guide plate 18. The LED holding recess 18a has a circular plan-view shape.

The bottom of the LED holding recess 18a, that is, a surface facing toward the rear side or the light-emitting surface of the LED 16 is a light entrance surface 18b through which light emitted from the light-emitting surface enters the light guide plate 18. The light entrance surface 18b is parallel to the X-Y plane (or the display surface 11a). The center C of the X-Y plane of the light entrance surface 18b is aligned with the center C of the X-Y plane of the LED 16 (see FIG. 8). The front surface of the light guide plate 18, that is, the opposed surface thereof to the diffuser 15b is a light exit surface 18c through which light exits from the light guide plate 18. The light exit surface 18c is an entire front surface of the light guide plate 18 parallel to the X-Y plane, that is, the light entrance surface 18b. Light emitted from the LED 16 forms a point light in plan view. The light that forms a point in plan view travels through the light guide plate 18 and exits therefrom through the light exit surface 18c as planar light. Namely, the light source unit U including the light guide plate 18 and the LED 16 is a surface-emitting planar light source that emits planar light through the light exit surface 18b. The center C of the X-Y plane of the light exit surface 18b is also aligned with the center C of the LED 16.

Furthermore, a reflection sheet 22 is arranged on the rear surface of the light guide plate 18, that is, the surface opposite from the light exit surface 18c other than the LED holding recess 18a (hereinafter referred to as a reflection sheet attached surface 18d). The reflection sheet 22 is provided for reflecting light toward the light exit surface 18c. The reflection sheet 22 is made of synthetic resin with a white or silver surface having high light reflectivity. The reflection sheet 22 is attached to the reflection sheet attached surface 18d of the light guide plate 18 with adhesive. The light reflectivity of the light reflection sheet 22 is preferably equal to or higher than 80%. The reflection sheet 22 is arranged between the light guide plate 18 and the LED board 17. The reflection sheet 22 has an opening 22a for passing the LED 16 in an area corresponding to the LED 16 in plan view. A plan-view size of the opening 22a is smaller than that of the LED holding recess 18a, that is, edges of the opening 22a project over the inside of the LED holding recess 18a. A side surface 18e of the light guide plate 18 facing a side surface of the adjacent light guide plate 18 via a gap (an interface with an air layer AR) is substantially flat along the Z-axis direction. Therefore, irregular reflection does not occur at the side surface 18e, which is the interface with the air layer AR. Rays of light traveling through the light guide plate 18 and enter the side surface 18e at angles larger than a critical angle are totally reflected. Therefore, the light is less likely to leak out of the light guide plate 18.

The backlight unit 12 of this embodiment is a direct backlight, the LEDs 16 of which are arranged directly behind the light guide plates 18. In comparison to a sidelight backlight unit, light use efficiency and brightness are higher. However, the brightness tends to be higher around the LEDS 16 in a brightness distribution within the light exit surfaces 18c, that is, uneven brightness is more likely to occur. Such a problem become even serious when the thicknesses of the light guide plates 18 are reduced or the intensity thereof is increased for improving the brightness.

To solve the above problem, this embodiment has the following configurations. The light entrance surface 18b of each light guide plate 18 has a first light scattering structure 23 that scatters light. A light reflector 24 is arranged on the light exit surface 18c of each light guide plate 18. The reflection sheet attached surface 18e of each light guide plate 18 has a second light scattering structure.

First, the first light scattering structure 23 will be explained in detail. As illustrated in FIGS. 5 and 8, the first light scattering structure 23 is formed in the light entrance

surface 18b by a mold (not shown) used for plastic molding of the light guide plates 18. The first light scattering structure 23 includes a plurality of annular protrusions 23a. The annular protrusions 23a are formed in ring-like shapes in plan view arranged around the center C of the X-Y plane of the light entrance surface 18 or the LED 16. Namely, the annular protrusions 23a are arranged concentrically with each other around the center C of the light entrance surface 18b or the LED 16. Each annular protrusion 23a has an inverted V-shaped cross section (substantially triangle). Surfaces of the annular protrusion 23a are angled relative to the Z-axis direction, that is, the light axis LA of the LED 16. The rays of light emitted from the LED 16 through the light-emitting surface 16a hit the tilted surfaces of the annular protrusions 23a. Namely, the rays of light tend to be scattered. The rays of light are scattered by the first light scattering structure 23 such that the light spreads along the X-Y plane of the light guide plate 18, that is, along the directions parallel to the light entrance surface 18b over a large area, and enters the light guide plate 18.

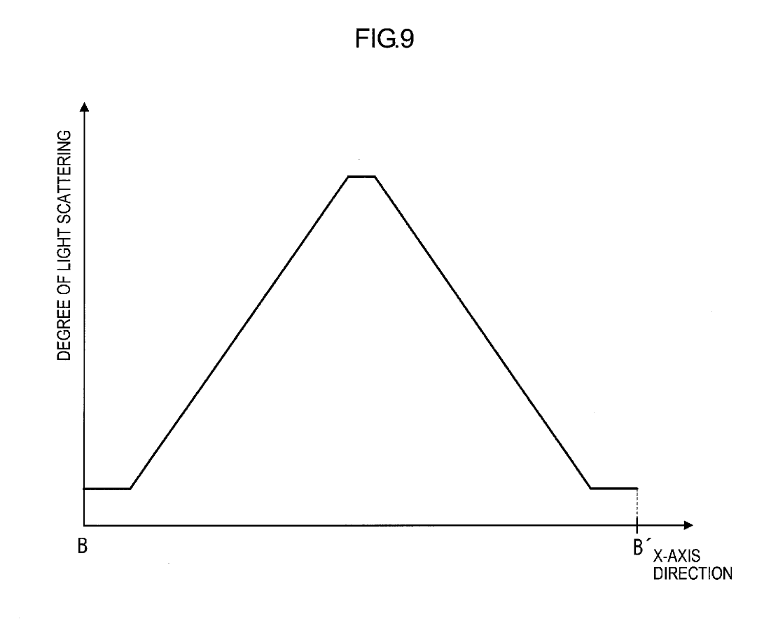

A plurality of the annular protrusions 23a are arranged such that ones having larger diameters are arranged farther from the center C of the light entrance surface 18b or the LED 16, and ones having smaller diameters are closer to the center C. Heights of the annular protrusions 23a from the light entrance surface 18b (the Z-axis dimension) are substantially the same. Widths of the annular protrusions 23a (the X-axis dimension or the Y-axis dimension) measured at bases become smaller as the distance from the center C decreases, and larger as the distance from the center C increases. Intervals between the annular protrusions 23a become smaller as the distance from the center C increases, and larger as the distance from the center C decreases. Therefore, a distribution density of the annular protrusions 23a on the light entrance surface 18b (the number of the annular protrusions 23a per unit area) becomes lower as the distance from the center C increases, higher as the distance from the center C decreases. As illustrated in FIG. 9, a degree of light scattering at the light entrance surface 18b becomes higher as the distance from the center C increases, and lower as the distance from the center C decreases. FIG. 9 is a chart illustrating degrees of light scattering plotted at X-axis points between point B and point B′ on the light entrance surface 18b (along the long-side direction of the light guide plate 18). The widths, the intervals, and the distribution density of the annular protrusions 23a gradually vary. The degrees of the light scattering at the light entrance surface 18b also gradually vary. Angles of the tilted surfaces of the annular protrusions 23a relative to the Z-axis direction become larger as the distance from the center C increases, and smaller as the distance from the center C decreases.

The amounts of light from the LED 16 become smaller as the distance from the center C increases, and larger as the distance from the center C decreases. The degree of the light scattering at the light entrance surface 18b varies proportional to the distribution of the amounts of the light from the LED 16.

In an area in which the amounts of the light from the LED 16 are relatively large, the degrees of the light scattering at the light entrance surface 18b are relatively high. In an area in which the amounts of light from the LED 16 are relatively small, the degrees of the light scattering at the light entrance surface 18b are relatively low. Therefore, a constant in-plane distribution of light entering from the light entrance surface 18b can be achieved. As a result, the LED 16 is less likely to be viewed through the light guide plate 18, that is, a lamp image is less likely to appear.

In the above description, a reference position of the light entrance surface 18b is at the bases of the annular protrusions 23a. However, the reference position of the light entrance surface 18b may be set at the distal ends of the annular protrusions 23a. Namely, the light entrance surface 18b may have annular recesses.

Next, the light reflector 24 will be explained in detail. As illustrated in FIG. 6, the light reflector 24 includes a number of dots 24 having substantially round plan-view shapes and arranged on the light exit surface 18c. The dots 24a of the light reflector 24 are radially arranged around the center of the light exit surface 18c or the LED 16. The dots 24a are formed by printing metal oxide pastes on the light exit surface 18c, that is, integrally provided with the light exit surface 18c. Screen printing or inkjet printing may be suitable for the printing of the dots 24a. A material used for the dots 24a has white or silver surfaces with larger light reflectivity than that of the material used for the light guide plate 18.

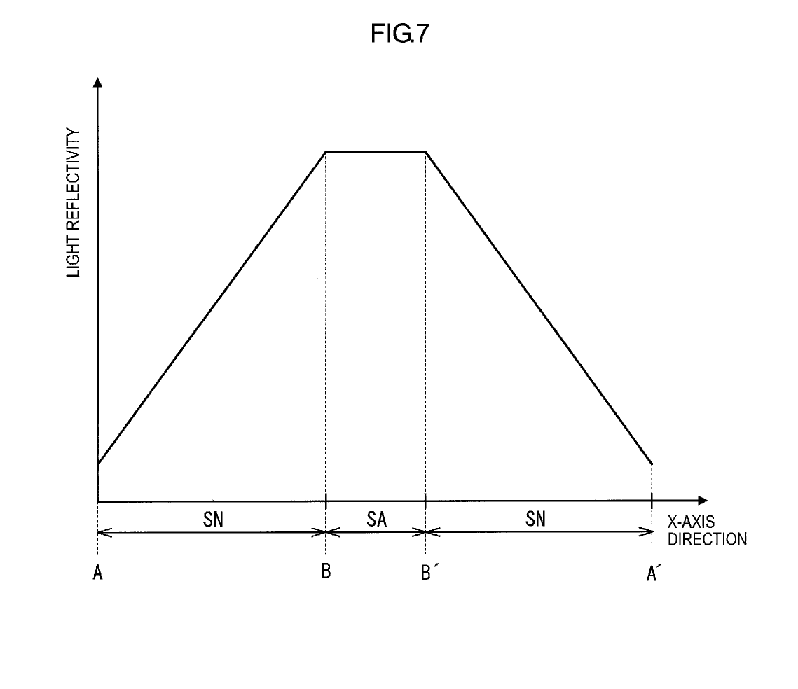

The light reflector 24 is configured such that the light reflectivity varies from area to area within the light exit surface 18c. Specifically, the light exit surface 18c includes a light-source overlapping area SA and light-source non-overlapping areas SN. The light source overlapping area SA overlaps the LED 16 and the light-source non-overlapping areas SN do not overlap the LED 16. The dots 24a of the light reflector 24 are arranged in both light source overlapping area SA and light-source non-overlapping areas SN, that is, an entire area of the light exit surface 18c in a predetermined distribution. The diameter of each dot 24a varies according to locations, that is, the area of each dot 24a varies according to the locations. The areas of the dots 24a are substantially the same in the light source overlapping area SA. In the light-source non-overlapping areas SN, the areas of the dots 24a become gradually smaller as the distance from the center C of the light exit surface 18c or the LED 16 increases, that is, gradually larger as the distance from the center C decreases. As illustrated in FIG. 7, the light reflectivity at the light exit surface 18c is substantially constant in the light source overlapping area SA. In the light-source non-overlapping areas SN, the light reflectivity gradually decreases as the distance from the center C increases, and increases as the distance from the center C decreases. FIG. 7 is a chart illustrating the light reflectivity plotted at X-axis points between point A and point A′ on the light entrance surface 18b (along the long-side direction of the light guide plate 18).

The amount of light in the light guide plate 18 decreases as the distance from the center C increases, and increases as the distance from the center C decreases. The light reflectivity at the light exit surface 18c varies proportional to the amount of light in the light guide plate 18. In the area in which the amount of light is relatively large, the light reflectivity is set relatively high so as to reduce the amount of exiting light. In the area in which the amount of light is relatively small, the light reflectively is set relatively low so as to increase the amount of exiting light. As a result, a uniform in-plane distribution of light exiting from the light exit surface 18c can be achieved.

Next, the second light scattering structure 25 will be explained in detail. As illustrated in FIGS. 5 and 8, the second light scattering structure 25 is formed in the reflection sheet attached surface 18d by a mold (not shown) used for plastic molding of the light guide plates 18. The second light scattering structure 25 includes a plurality of annular protrusions 25a. The annular protrusions 25a are formed in ring-like shapes in plan view arranged around the center C of the X-Y plane of the light entrance surface 18 or the LED 16. Namely, the annular protrusions 25a are arranged concentrically around the center C of the light entrance surface 18b or the LED 16. Each annular protrusion 25a has an inverted V-shaped cross section (substantially triangle). Surfaces of the annular protrusion 25a are angled relative to the Z-axis direction, that is, the light axis LA of the LED 16. The rays of light travel through the light guide plate 18 and reach the reflection sheet attached surface 18d. The rays of light hit the tilted surfaces of the annular protrusions 25a. Namely, the rays of light are likely to be scattered. The rays of light at the reflection light attached surface 18d are scattered by the second light scattering structure 25 and guided toward the light exit surface 18c. The rays of light enter the light exit surface 18c at angles smaller than the critical angle and exit the light guide plate 18 through the light exit surface 18c. The amount of light exiting from the light exit surface 18c varies proportional to the degree of the light scattering by the second light scattering structure 25. Each of the annular protrusions 25a located farther away from the center C than a half of the short dimension of the light guide plate 18 has an open-end ring shape.

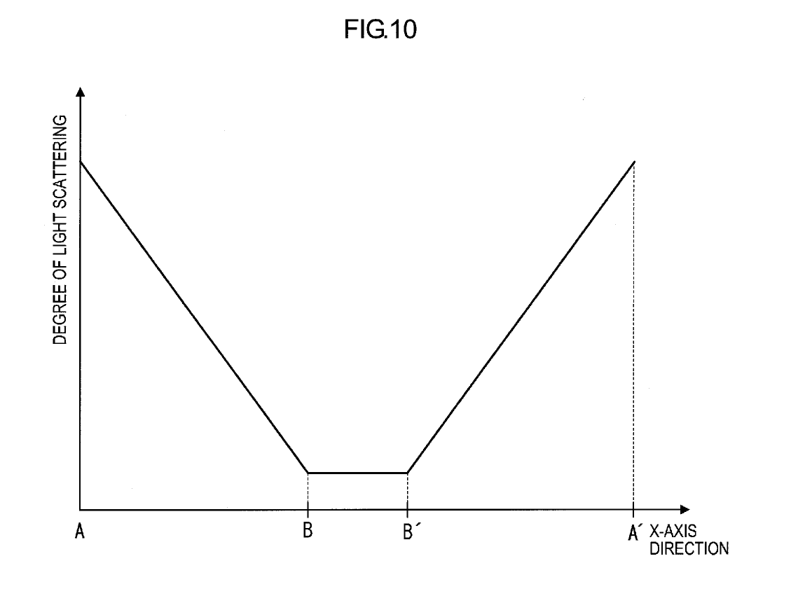

A plurality of the annular protrusions 25a are arranged such that ones having larger diameters are located farther from the center C of the LED 16 and ones having smaller diameters are located closer to the center C. Heights of the annular protrusions 25a from the reflection sheet attached surface 18d (the Z-axis dimension) are substantially the same. Widths of the annular protrusions 25a (the X-axis dimension or the Y-axis dimension) measured at bases become smaller as the distance from the center C decreases, and larger as the distance from the center C increases. Intervals between the annular protrusions 25a become smaller as the distance from the center C increase, and larger as the distance from the center C decreases. Therefore, a distribution density of the annular protrusions 25a on the reflection sheet attached surface 18d is lower as the distance from the center C increases, that is, higher as the distance from the center C decreases. As illustrated in FIG. 10, a degree of light scattering at the reflection sheet attached surface 18d is higher as the distance from the center C increases, and lower as the distance from the center C decreases. FIG. 10 is a chart illustrating degrees of light scattering plotted at X-axis points between point A and point A′ at the reflection sheet attached surface 18d (along the long-side direction of the light guide plate 18). The widths, the intervals, and the distribution density of the annular protrusions 25a gradually vary. The degrees of the light scattering at the reflection sheet attached surface 18d also gradually vary. Angles of the tilted surfaces of the annular protrusions 25a relative to the Z-axis direction become smaller as the distance from the center C increases, and larger as the distance from the center C decreases.

The amount of light in the light guide plate 18 becomes smaller as the distance from the center C increases, and larger as the distance from the center C decreases. The degree of the light scattering at the reflection sheet attached surface 18d varies inversely proportional to the distribution of the amount of the light in the light guide plate 18. In an area in which the amount of light in the light guide plate 18 is relatively large, the degrees of the light scattering at the reflection sheet attached surface 18d are relatively high. In an area in which the amounts of light from the LED 16 are relatively small, the degrees of the light scattering at the reflection sheet attached surface 18d are high. Therefore, a constant in-plane distribution of light entering from the light exit surface 18c can be achieved. With this configuration together with the first light scattering structure 23 and the light reflector 24, uneven brightness on the light exit surface 18c is properly reduced.

In the above description, a reference position of the reflection sheet attached surface 18d is at the bases of the annular protrusions 25a. However, the reference position of the reflection sheet attached surface 18d may be set at the distal ends of the annular protrusions 25a. Namely, the reflection sheet attached surface 18d may have annular recesses.

This embodiment has the above configurations. Next, functions of this embodiment will be explained. When the liquid crystal display device 10 is turned on, the LEDs 16 are lit. As illustrated in FIG. 5, light emitted from each LED 16 through the light-emitting surface 16a enters the light guide plate 18 through the light entrance surface 18b, travels through the light guide plate 18, and exits from the light exit surface 18c.

Specifically, when the light from each LED 16 reach the light entrance surface 18b, it is scattered by the first light scattering structure 23 formed in the light entrance surface 18b. The degree of light scattering by the first light scattering structure 23 within the light entrance surface 18b changes proportional to the distribution of the amount of light emitted from the LED 16. Therefore, the light spreads out to a large area in the light guide plate 18 along the light entrance surface 18b. The light is less likely to directly exit from the light exit surface 18c and a uniform in-plane light distribution can be achieved.

Light traveling through the light guide plate 18 and toward the reflection sheet 22 is scattered by the second light scattering structure 25 formed in the reflection sheet attached surface 18d. More rays of light travel toward the reflection sheet 22 (or the reflection sheet attached surface 18d) in areas closer to the LED 16, and less rays of light travel toward the reflection sheet 22 in areas farther from the LED 16. The degree of light scattering by the second light scattering structure 25 is inversely proportional to the number of rays traveling through the light guide plate 18 and toward the reflection sheet 22. Therefore, the rays of light are less likely to be scattered in areas relatively closer to the LED 16 and through which a larger number of rays travel, and more likely to be scattered in areas relatively farther from the LED 16 and through which a smaller number of rays travel. An area close to point B or point B′ in FIG. 8 is an example of the areas relatively closer to the LED 16. An area close to point A or point A′ in FIG. 8 is an example of the areas relatively farther from the LED 16. If the rays of light are less likely to be scattered by the reflection sheet attached surface 18d, more rays among the rays guided toward the light exit surface 18c by the reflection sheet 22 enter the light exit surface 18c at angles larger than the critical angle. Namely, the rays are more likely to be totally reflected. If the rays are more likely to be scattered by the reflection sheet attached surface 18d, fewer rays among the rays guided toward the light exit surface 18c enter the light exit surface 18c at angle smaller than the critical angle. Namely, the rays are less likely to be totally reflected. As the number of rays toward the reflection sheet 22 increases, the number of rays exiting from the light exit surface 18 decreases. As the number of rays toward the reflection sheet 22 decreases, the number of rays exiting from the light exit surface 18 increases. Therefore, light evenly exits from the light exit surface 18c.

The rays include direct rays and indirect rays. The direct rays travel through the light guide plate 18 and directly reach the light exit surface 18c. The indirect rays reach the light exit surface 18c after reflected by the reflection sheet 22 and the side surfaces 18e. The in-plane distribution of the direct rays on the light exit surface 18c is evened to some degree by the first light scattering structure 23. The in-plane distribution of the indirect rays on the light exit surface 18c is evened to some degree by the second light scattering structure 24. In this embodiment, the in-plane distribution is further evened by the light reflector 24 arranged on the light exit surface 18c. In the light-source overlapping area SA, the light reflectivity of the light reflector 24 on the light exit surface 18c is constant at a relatively high level. In each light-source non-overlapping area SN, the light reflectivity is lower than that in the light-source overlapping area SA. Furthermore, the light reflectivity increases as the distance from the LED 16 (or the light-source overlapping area SA) decreases and decreases as the distance from the LED 16 increases. In the light-source overlapping area SA in which the number of rays traveling through the light guide plate 18 toward the light exit surface 18c is relatively large, a large number of the rays are reflected toward the rear side by a relatively large area of the light reflector 24, and the output of light from the light exit surface 25 is reduced. In the light-source non-overlapping areas SN in which the number of rays traveling toward the light exit surface 18c is relatively small, a small number of the rays are reflected toward the rear side by a relatively small area of the light reflector 24, and the output of light from the light exit surface 25 is increased. Furthermore, each light-source non-overlapping area SN is configured such that the light reflectivity varies as described above. Therefore, the amount of light reflected by the light reflector 24 and the amount of light exiting from the light exit surface 18c are properly controlled according to the amount of light in the light guide plate 18. As a result, the in-plane distribution of the amount of light exiting from the light exit surface 18c per the entire area of the light exit surface 18c is evened.

Each light guide plate 18 is configured such that light exits from the light exit surface 18c. As illustrated in FIG. 4, the air layers AR are provided between the light guide plates 18 that are two-dimensionally arranged in a parallel layout inside the chassis 14. Each air layer AR has a refractive index smaller than that of the light guide plate 18. Therefore, light inside each light guide plate 18 is less likely to leak to the adjacent light guide plates 18 through the side surfaces 18e. Namely, rays of light do not travel between the adjacent light guide plates 18 or mix together. The light guide plates 18 are optically independent from one another. The LEDs 16 arranged so as to correspond to the respective light guide plates 18 can be independently turned on and off. Therefore, outputs of light from the light guide plates 18 through the light exit surfaces 18c can be independently controlled. With this configuration, driving of the backlight unit 12 can be controlled by using a technology called Area Active technology. Contrast performance of the liquid crystal display device 10, which is very important display performance, can be significantly improved.

As described above, the backlight unit 12 of this embodiment includes the LEDs 16, the light guide plates 18, and the light reflectors 24. The LEDs 16 are light sources. Each light guide plate 18 has the light entrance surface 18b and the light exit surface 18c. The light entrance surface 18b has the first light scattering structure 23. The light exit surface 18c is parallel to the light entrance surface 18b and through which light exits. The light reflector 24 is arranged on the light exit surface 18c and configured to reflect light.

The light entrance surface 18b and the light exit surface 18c of each light guide plate 18 are parallel to each other. With the light guide plates 18, the light emitted by the LEDs 16 can be efficiently used and thus the intensity of light exiting from the light exit surface 18c can be increased. With the above configuration, high brightness can be achieved; however, uneven brightness is more likely to occur because the brightness is locally high in areas of the light exit surfaces 18c around the LEDs 16. In this embodiment, the first light scattering structures 23 are provided in the light entrance surfaces 18b and the light reflectors 24 are arranged on the light exit surfaces 18c. The functions and the operations of the first light scattering structures 23 and the light reflectors 24 are as follows.

The light from each LED 16 is scattered by the first scattering structure 23 when enters the light entrance surface 18b. Therefore, the brightness in the areas of the light exit surface 18c around the LED 16 can be reduced. When the light inside the light guide plate 18 reaches the light exit surface 18c, the light is reflected by the light reflectors 24 at rates corresponding to the light reflectivities of the light reflectors 24. By adjusting the light reflectivities of the light reflectors 24 and with the first light scattering structure 23, the brightness distributions on the light exit surface 18c can be evened. With this configuration, the uneven brightness can be properly compensated while high brightness is achieved. Thinner light guide plates can be used to reduce the thicknesses of the backlight unit 12 and the liquid crystal display device 10. Moreover, high intensity LEDs can be used to increase the brightness. Therefore, the backlight unit 12 and the liquid crystal display device 10 with smaller thicknesses can be provided. Furthermore, the liquid crystal display device 10 with significantly high display quality can be provided.

The first light scattering structure 23 is configured such that the degree of light scattering within the light entrance surface 18b decreases as the distance from the center C of the LED 16 increases. The amount of emitted light from the LED 16 decreases as the distance from the center C from the LED 16 increases and the degree of light scattering by the first light scattering structure 23 varies proportional to the distribution of emitted light from the LED 16. Therefore, the uneven brightness is further properly reduced.

The LED 16 forms a point-like shape when viewed in the plane of the light exit surface 18c. The first light scattering structure 23 includes a plurality of the annular protrusions 23a (or the annular recesses) having ring-like shapes so as to surround the center C of the LED 16 having the point-like shape. The emitted light from the LED 16 can be appropriately scattered by the annular protrusions 23a.

The annular protrusions 23a are concentrically arranged with each other around the center C of the LED 16. By adjusting the annular protrusions 23a (e.g., adjusting the intervals), the degree of light scattering can be easily adjusted.

The light reflector 24 is integrally provided with the light exit surface 18c. If a light reflector is provided separately from the light exit surface 18c, a gap may be created between the light exit surface 18c and the light reflector. With the above configuration, such problems are less likely to occur. Therefore, preferable light reflection performance can be achieved.

The light reflector 24 is printed on the light exit surface 18c. If the light reflection function is established by forming the light exit surface into an appropriate shape, a high accuracy is required in the forming process of the light exit surface. This may decrease yield. With the above configuration, such a problem is less likely to occur and thus yield can be improved. This contributes to a cost reduction.

The light reflector 24 is configured such that the light reflectivity differs from area to area of the light exit surface 18c. The reflection efficiency and the emitting efficiency of light that has reached at the light exit surface 18c differ from area to area of the light exit surface 18c due to the light reflector 24. Therefore, the uneven brightness is properly reduced.

The light reflector 24 is arranged in at least in the light-source overlapping area SA of the light exit surface 18c, which overlaps the LED 16. Therefore, a shadow of the LED 16 is less likely to be viewed through the light guide plate 18. The uneven brightness is further properly reduced.

The light reflector 24 may be also arranged in the light-source non-overlapping areas SN of the light exit surface 18c, which do not overlap the LED 16. The light reflectivity in the light-source overlapping area SA is higher than the light reflectivities in the light-source non-overlapping areas SN. In the light-source overlapping area SA in which the amount of light in the light guide plate 18 is relatively large, the light reflectivity of the light reflector 24 is relatively high. Therefore, light is more likely to be reflected. The reflected light is then guided to the light-source non-overlapping areas SN in which the amount of light is relatively small. In the light-source non-overlapping areas SN, the light reflectivity of the light reflector 24 is relatively low and thus the light is more likely to transmit therethrough. With this configuration, the efficiency of outputting light through the light exit surface 18c can be evened.

The light reflector 24 is formed such that the light reflectivity thereof within the light exit surface 18c decreases as the distance from the LED 16 increases. By adjusting the light reflectivity such that the reflectivity of the light reflector 24 within the light exit surface 18c varies proportional to the distribution of the amount of light in the light guide plate 18, the uneven brightness is properly reduced.

The light reflector 24 includes a number of dots 24a having point-like shapes when viewed in plane of the light exit surface 18c and light reflectivities. The light reflectivity can be easily adjusted by changing the configuration of the dots 24a (e.g., areas, distribution density).

The dots 24a are formed such that the areas thereof gradually decrease as the distance from the center C of the LED 16 increases. By changing the areas of the dots 24a proportional to the distribution of the amount of light in the light guide plate 18, the uneven brightness is further properly reduced.

The dots 24a are formed such that the areas thereof gradually decrease as the distance from the center C of the LED increases. By changing the distribution density, the distribution density of the dots 24a changes proportional to the distribution of the amount of light in the light guide plate 18. As a result, the uneven brightness is further properly reduced.

The LED 16 has a point-like shape within a light exit surface 18c. The dots 24a are radially arranged around the center C of the LED 16. With the dots 24a radially arranged, the efficiency of outputting light from the light exit surface 18c can be evened.

The surface of the light reflector 24 is white or silver. High light reflectivity can be achieved at the surface. The function for controlling the amount of reflected light can be further improved.

The reflection sheet 22 is arranged on the surface of the light guide plate 18 opposite from the light exit surface 18c. The reflection sheet 22 reflects light toward the light exit surface 18c. With this configuration, the light is effectively guided to the light exit surface 18c and the brightness can be improved.

The second light scattering structure 25 is provided in the reflection sheet attached surface 18d of the light guide plate 18. With this configuration, the light scattered by the second light scattering structure 25 is reflected toward the light exit surface 18c by the reflection sheet 22. The amount of light exit from the light exit surface 18c tends to change proportional to the degree of light scattering by the second light scattering structure 25. Namely, the efficiency of emitting light from the light exit surface 18c can be controlled according to the degree of light scattering by the second light scattering structure 25. This contributes to reducing the uneven brightness.

The second light scattering structure 25 is formed such that the degree of light scattering within the reflection sheet attached surface 18d increases as the distance from the LED 16 increases. With this configuration, the amount of light in the light guide plate 18 tends to decrease as the distance from the LED 16 increases. The degree of light scattering by the second light scattering structure 25 within the surface of the reflection sheet 22 changes inversely proportional to the distribution of the amount of light within the light guide plate 18. Therefore, the efficiency of emitting light from the light exit surface 18c can be further evened, and the uneven brightness can be further properly reduced.

The LED 16 has a point-like shape when viewed in the plane of the light exit surface 18c. The second light scattering structure 25 includes a plurality of the annular protrusions 25a (or annular recesses) having ring-like shapes so as to surround the LED 16. Light in the light guide plate 18 is appropriately scattered by the annular protrusions 25a.

The annular protrusions 25a are arranged concentrically with each other around the center C of the LED 16. With this configuration, the degree of light scattering can be controlled by adjusting the configuration of the annular protrusions 25a (e.g., arrangement intervals).

The light guide plate 18 has the LED holding recess 18a that holds the LED 16 in the surface opposite from the light exit surface 18c. The inner surface of the LED holding recess 18a includes the light entrance surface 18b. The LED 16 is arranged in the LED holding recess 18a of the light guide plate 18. Therefore, the overall thickness can be reduced.

A plurality of the light guide plates 18 and a plurality of the LEDs 16 are arranged parallel to each other and in at least one of the directions along the light exit surface 18c. This configuration is especially suitable for large screen applications.

The light guide plates 18 and the LEDs 16 are two-dimensionally arranged so as to be parallel to each other. This configuration is suitable for larger screen applications.

The air layers AR are provided between the adjacent light guide plates 18. Each air layer AR is a low refraction-index layer having a refraction index lower than that of the light guide plate 18. Light in each light guide plate 18 can be totally reflected by the side surface 18e that is an interface of the light guide plate 18 with the air layer AR. Light in the light guide plate 18 and light in the adjacent light guide plate 18 are not mixed. Therefore, control of outputting light from the light exit surface 18c of the light guide plate 18 can be independently performed for each light guide plate 18. Furthermore, additional parts are not required for providing low refractive-index layers. Therefore, the low refractive-index layers can be prepared at low cost.

The light sources are the LEDs 16. Therefore, high brightness can be achieved.

The present invention is not limited to the first embodiment explained in the above description. The following modifications may be included in the technical scope of the present invention, for example. In the modifications, similar parts to those in the first embodiment will be indicated by the same symbols, and may not be illustrated or explained.

### First Modification of the First Embodiment

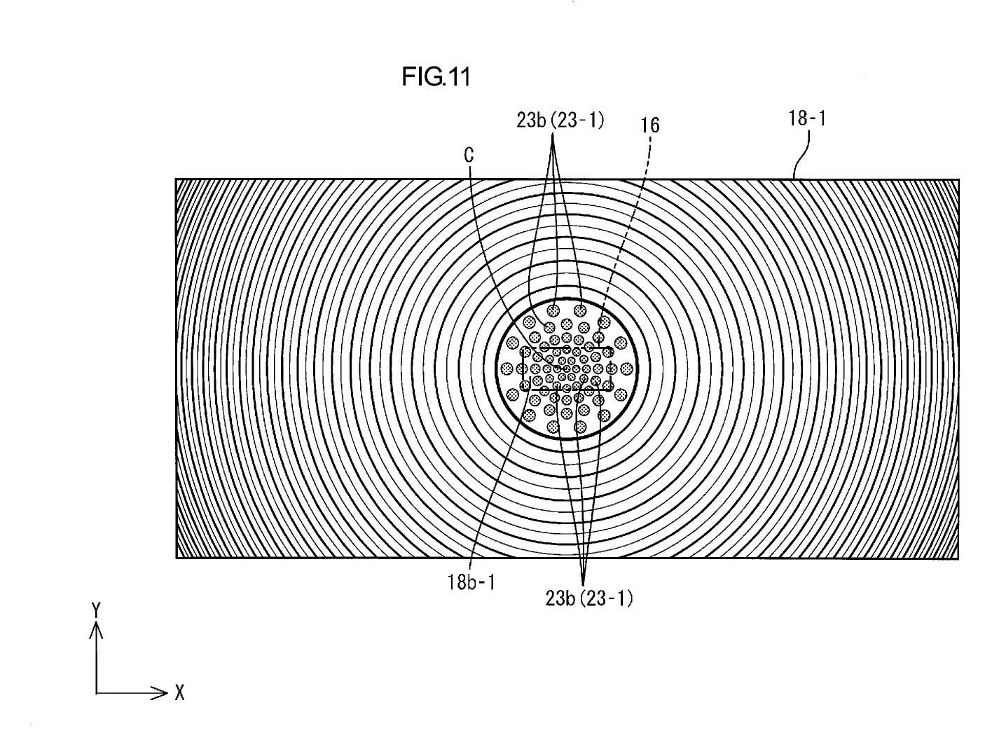

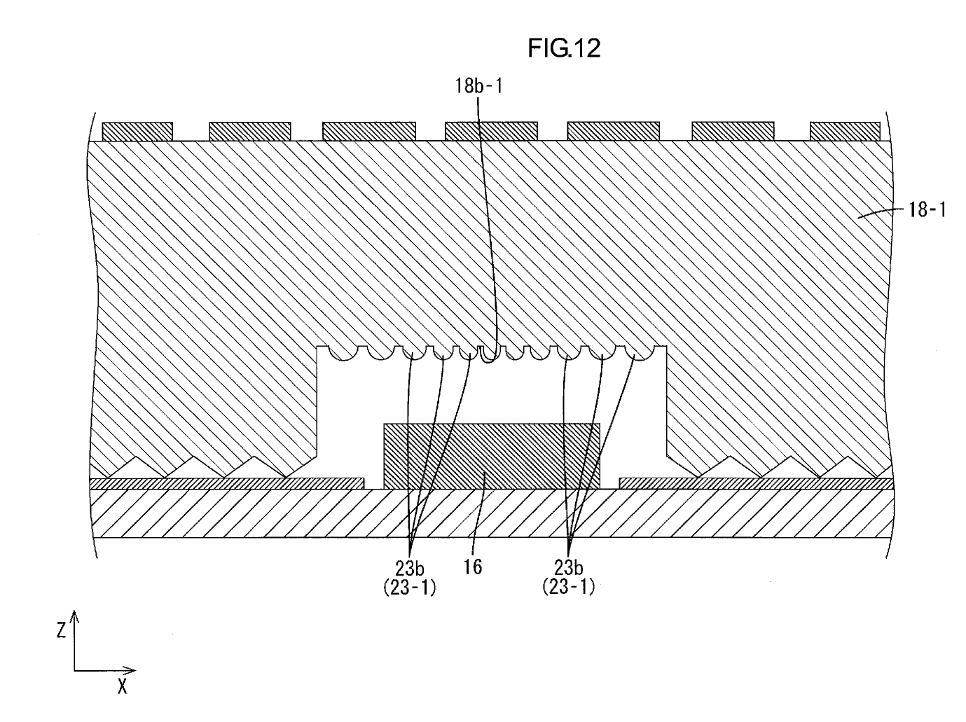

The first modification of the first embodiment will be explained with reference to FIGS. 11 and 12. First light scattering structures 23-1 having different configurations are used in this modification.

Each first light scattering structure 23-1 includes a plurality of round protrusions 23b formed on a light entrance surface 18b-1 and having round shapes when viewed in plan. Each round protrusion 23b has a round plan-view shape and a U-like cross sectional view that decreases in width toward a tip thereof. Each round protrusion 23b has a dome-like shape and a curved surface. Light emitted from the LED 16 hits the curved surfaces of the round protrusions 23b and thus tends to scatter. The round protrusions 23b are formed on the light entrance surface 18b-1 by a mold (not shown) used for plastic molding of the light guide plate 18-1.

The round protrusions 23b are radially arranged around the center C of the LED 16 so as to increase in diameter and area as the distance from the center C decreases. The heights of the round protrusions 23b from the light entrance surface 18b-1 (the Z dimensions) are substantially the same. Intervals between the round protrusions 23b become smaller as the distance from the center C increases and become larger as the distance from the center C decreases. The distribution densities (the number of the round protrusions 23b per unit area) become lower as the distance from the center C increases and become higher as the distance from the center C decreases. The degrees of the light scattering at the light entrance surface 18b-1 become lower as the distance from the center C increases and become higher as the distance from the center C decreases (see FIG. 9). The areas, the intervals, and the distribution densities of the round protrusions 23b are defined so as to gradually change. The degrees of light scattering at the light entrance surface 18b-1 are also defined so as to gradually change.

In the above description, a reference position of the light entrance surface 18b-1 is at the base of each round protrusion 23b. However, the reference position of the light entrance surface 18b-1 may be set at the distal end of each round protrusion 23b. Namely, the light entrance surface 18b-1 may have round recesses.

The first modification of the first embodiment includes the first light scattering structures 23-1. Each light scattering structure 23-1 includes a plurality of the round protrusions 23b (or the round recesses) having round shapes and arranged within the light entrance surface 18b-1. The degrees of light scattering can be easily adjusted by changing the configuration of the round protrusions 23b (e.g., the areas, the distribution densities).

The round protrusions 23b are formed so as to increase in area as the distance from the center C of the LED 16 increases. By forming the round protrusions 23b such that the areas thereof. change inversely proportional to the distribution of the amount of emitted light from the LED 16, the uneven brightness is further properly reduced.

The round protrusions 23b are formed so as to decreases in distribution density as the distance from the center C of the LED 16 increases. By forming the round protrusions 23b such that the distribution densities thereof change proportional to the distribution of the amount of emitted light from the LED 16, the uneven brightness is further properly reduced.

The LED 16 has a round shape when viewed in the plane of the light exit surface. The round protrusions 23b are radially arranged around the center C of the LED 16. With this configuration, the emitted light from the LED 16 is properly scattered by the round protrusions 23b that are radially arranged.

### Second Modification of the First Embodiment

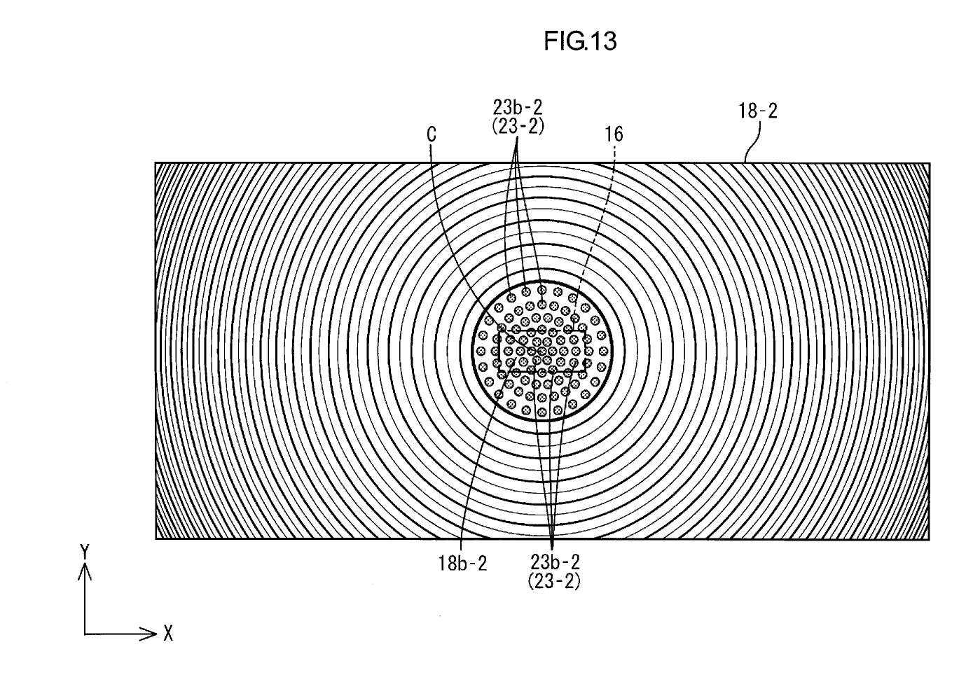

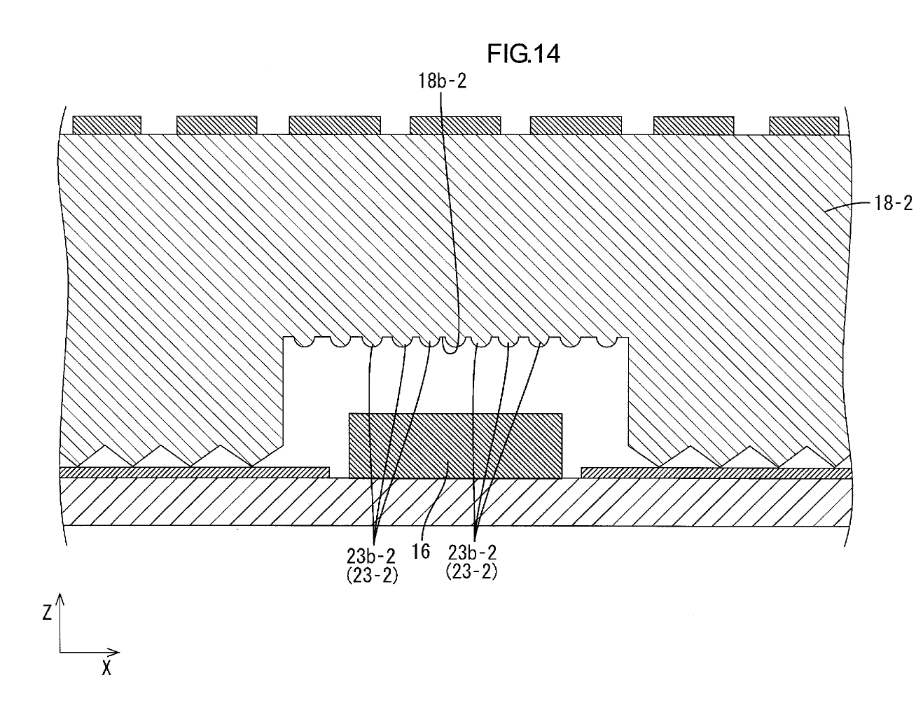

The second modification of the first embodiment will be explained with reference to FIGS. 13 and 14. First light scattering structures 23-1 having different configurations from the first modification are used in this modification. The same configurations as the first modification will not be explained.

Round protrusions 23b-2 included in each first light scattering structure 23-2 have substantially the same diameters and the same areas. The round protrusions 23b-2 are arranged within the light entrance surface 18b-2 at intervals and distribution densities different from area to area. Specifically, the round protrusions 23b-2 are arranged at larger intervals as the distance from the center C of the LED 16 increases and thus the distribution density decreases, and at smaller intervals as the distance from the center C of the LED 16 decreases and thus the distribution density increases. Namely, the round protrusions 23b-2 are unevenly arranged within the light entrance surface 18b-2. With this configuration, the degree of light scattering at the light entrance surface 18b-2 can be decreased as the distance from the center C increases and increased as the distance from the center C decreases. In the second modification, the diameters of the round protrusions 23b-2 are substantially the same and the areas of the round protrusions 23b-2 are substantially the same. Therefore, a mold for producing the light guide plates 18-2 can be easily designed.

### Third Modification of the First Embodiment

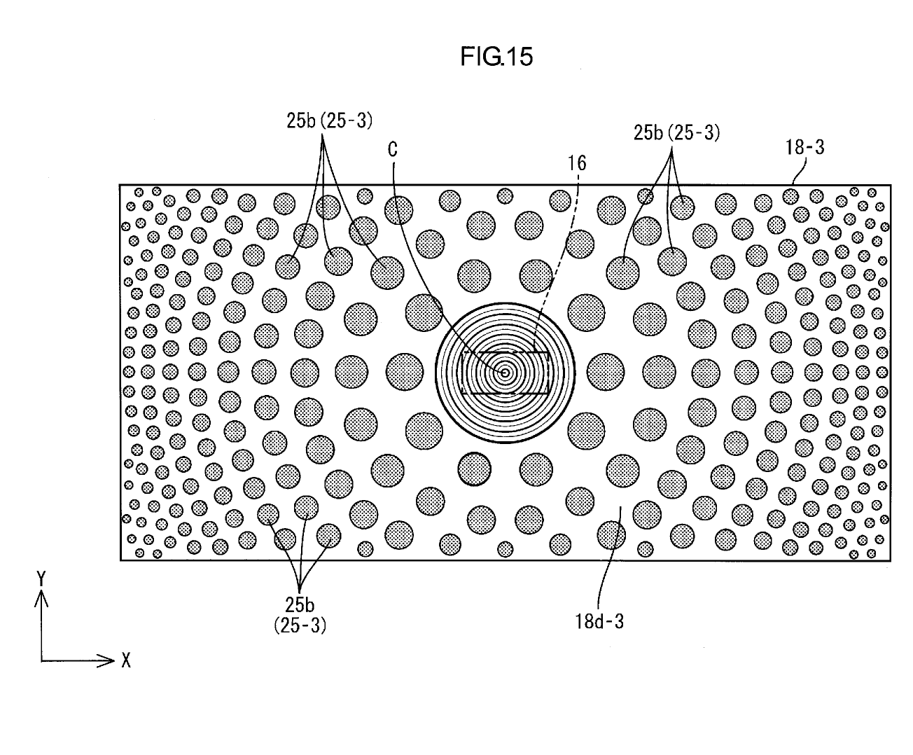

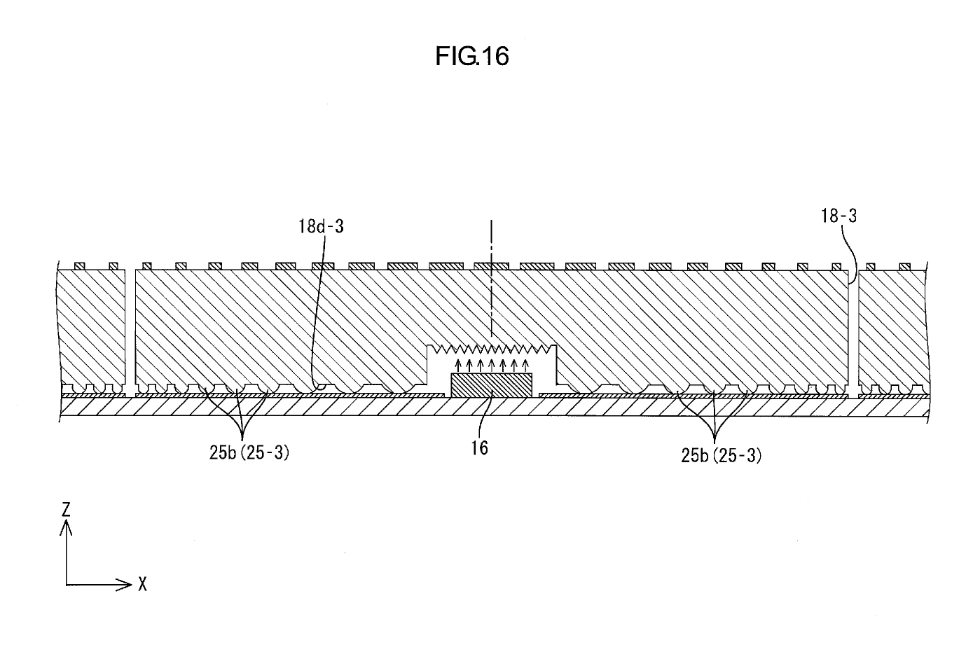

The third modification of the first embodiment will be explained with reference to FIGS. 15 and 16. Second light scattering structures 25-3 having different configurations will be explained.

Each second light scattering structure 25-3 includes a plurality of round protrusions 25b arranged within a reflection sheet attached surface 18d-3 and having round shapes when viewed in plan. Each round protrusion 23b has a round plan-view shape and a U-like cross sectional view that decreases in width toward a tip thereof. Each round protrusion 25b has a dome-like shape and a curved surface. Light that travels through the light guide plate 18-3 and reaches the reflection sheet attached surface 18d-3 hits the curved surfaces of the round protrusions 25b and thus tends to scatter. The round protrusions 25b are formed on the light entrance surface 18b-3 by a mold (not shown) used for plastic molding of the light guide plate 18-3.

The round protrusions 25b are radially arranged around the center C of the LED 16 so as to decrease in diameter and area as the distance from the center C increases and increases in diameter and area as the distance from the center C decreases. The heights of the round protrusions 25b from the reflection sheet attached surface 18d-3 (the Z dimensions) are substantially the same. Intervals between the round protrusions 25b become smaller as the distance from the center C increases and become larger as the distance from the center C decreases. The distribution densities (the number of the round protrusions 25b per unit area) become lower as the distance from the center C increases and become higher as the distance from the center C decreases. The degrees of the light scattering at the reflection sheet attached surface 18d-3 become lower as the distance from the center C increases and become higher as the distance from the center C decreases (see FIG. 10). The areas, the intervals, and the distribution densities of the round protrusions 25b are defined so as to gradually change. The degrees of light scattering at the reflection sheet attached surface 18d-3 are also defined so as to gradually change.

In the above description, a reference position of the reflection sheet attached surface 18d-3 is at the base of each round protrusion 25b. However, the reference position of the reflection sheet attached surface 18d-3 may be set at the distal end of each round protrusion 25b. Namely, the reflection sheet attached surface 18d-3 may have round recesses.

The third modification of the first embodiment includes the second light scattering structures 25-3. Each light scattering structure 25-3 includes a plurality of the round protrusions 25b having round shapes and arranged within the reflection sheet attached surface 18d-3. The degrees of light scattering can be easily adjusted by changing the configuration of the round protrusions 25b (e.g., the areas, the distribution densities).

The round protrusions 25b are formed so as to decrease in area as the distance from the center C of the LED 16 increases. By forming the round protrusions 25b such that the areas thereof change proportional to the distribution of the amount of light in the light guide plate 18-3, the uneven brightness is further properly reduced.

The round protrusions 25b are formed so as to increases in distribution density as the distance from the center C of the LED 16 increases. By forming the round protrusions 25b such that the distribution densities thereof change inversely proportional to the distribution of the amount of light in the light guide plate 18-3, the uneven brightness is further properly reduced.

The LED 16 has a round shape when viewed in the plane of the light exit surface. The round protrusions 25b are radially arranged around the center C of the LED 16. With this configuration, the light in the light guide plate 18-3 16 is properly scattered by the round protrusions 25b that are radially arranged.

### Fourth Modification of the First Embodiment

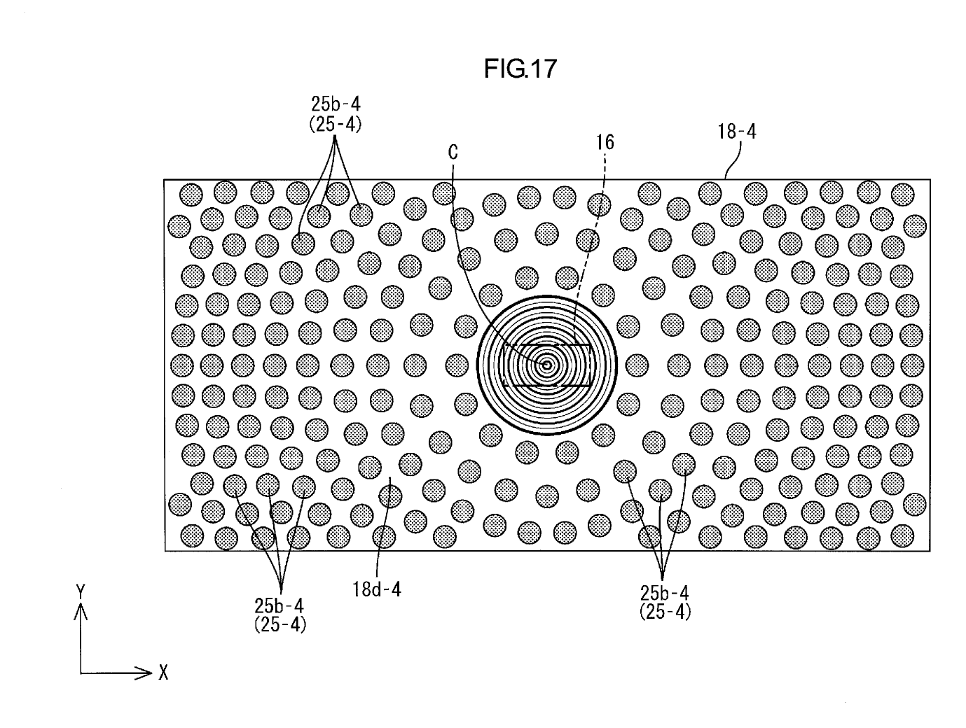

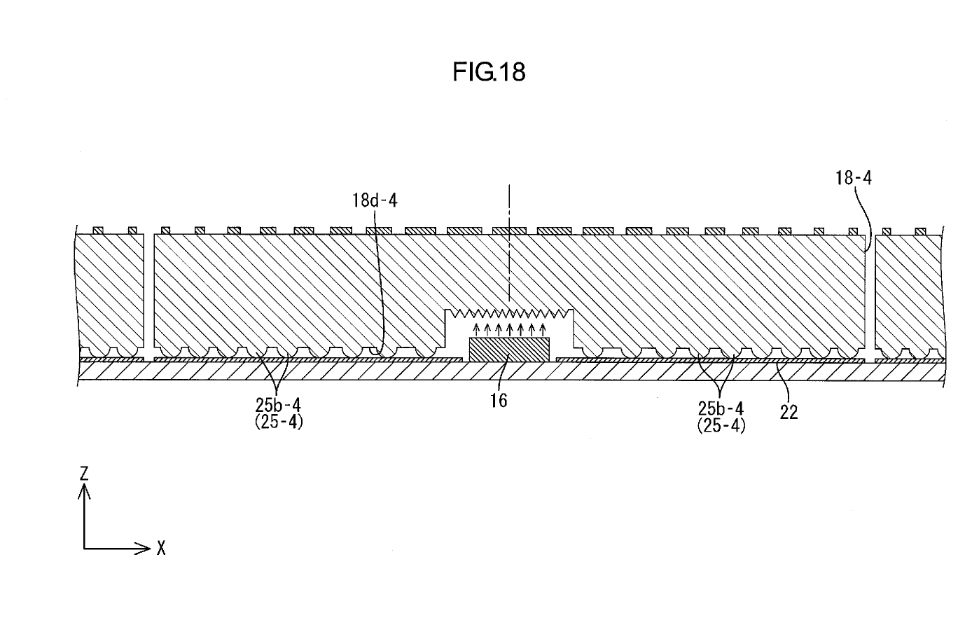

The fourth modification of the first embodiment will be explained with reference to FIGS. 17 and 18. First light scattering structures 25-4 having different configurations from the third modification will be explained. The same configurations as the first modification will not be explained.

Round protrusions 25b-4 of each first light scattering structure 25-4 are formed such that diameters and areas thereof are substantially the same. The round protrusions 25b-4 are arranged within the reflection sheet attached surface 18d-4 at intervals and distribution densities that are different from area to area. Specifically, the intervals of the round protrusions 25b-4 are smaller and the distribution density thereof are higher as the distance from the center C increases. Namely, the intervals of the round protrusions 25b-4 are larger and the distribution density thereof is lower as the distance from the center C decreases. By unevenly arranging the round protrusions 25b-4 within the reflection sheet attached surface 18d-4, the degree of light scattering at the reflection sheet attached surface 18d-4 can be set higher as the distance from the center C increases and lower as the distance from the center C decreases. In the fourth modification, the diameters and the areas of the round protrusions 25b-4 are substantially the same. Therefore, a mold used for producing the light guide plates 18-4 can be easily designed. This configuration may be made even more preferable if the configuration of the second modification is applied.

### Fifth Modification of the First Embodiment

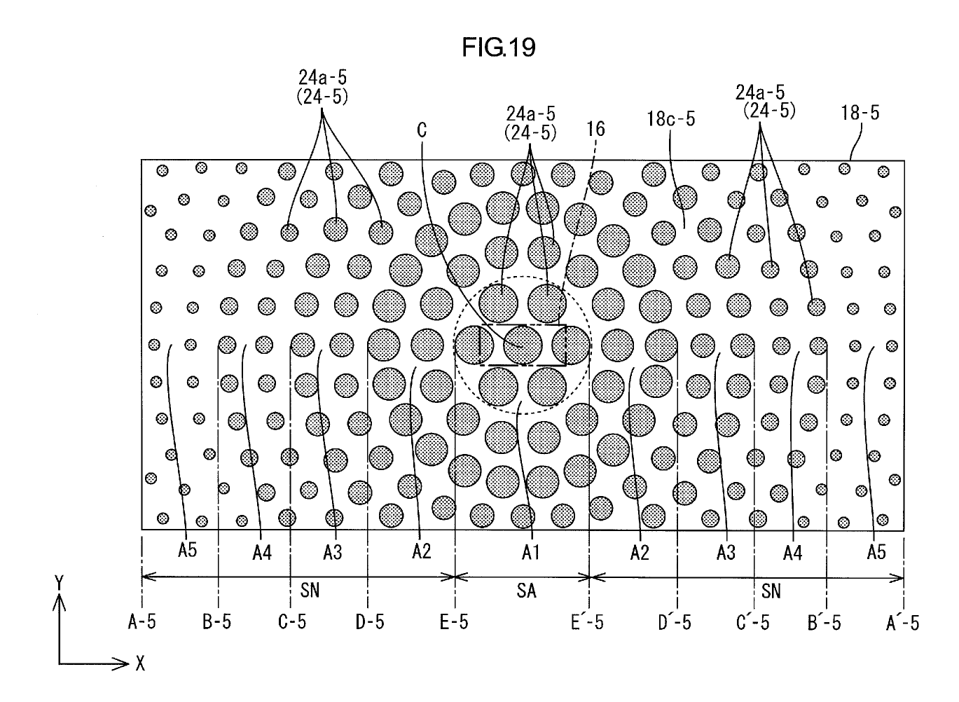

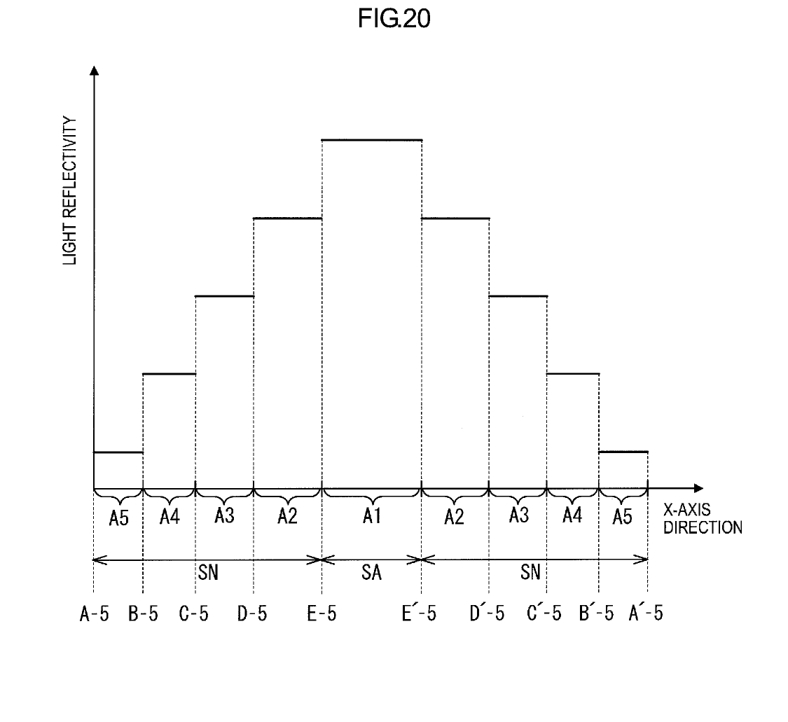

The fifth modification of the first embodiment will be explained with reference to FIGS. 19 and 20. Light reflectors 24-5 having different configurations will be explained.

Each light reflector 24-5 is formed such that light reflectivity thereof on a light exit surface 18c-5 changes stepwise according to the distance from the LED 16. Specifically, the light reflectivity at the light exit surface 18c-5 decreases stepwise as the distance from the center C increases, and increases stepwise as the distance from the center C decreases. The areas of dots 24a-5 of the light reflector 24-5 are the largest in the light-source overlapping area SA. In the light-source non-overlapping areas SN, the areas of the dots 24a-5 decreases stepwise as the distance from the LED 16 (or the light-source overlapping area SA) increases. Namely, variations in light reflectivity at the light exit surface 18c-5 according to the distance from the LED 16 form a bar chart.

More specifically, the light exit surface 18c-5 is divided into first, second, third, fourth, and fifth areas according to the light reflectivity that decreases stepwise from the first area to the fifth areas. The first area A1 is located between point E-5 and point E′-5 on the X-axis. Each second area A2 is located between point D-5 and point E-5 (or point D′-5 and E′-5). Each third area A3 is located between point D-5 and point C-5 (or point D′-5 and C′-5). Each fourth area A4 is located between point C-5 and point B-5 (or point C′-5 and point B′-5). Each fifth area A5 is located between point B-5 and point A-5 (point B′-5 and point A′-5). The areas A2 to A5 are ring-like areas formed concentrically with respect to the center C of the LED 16. The first area A1 is a round area corresponds to the light-source overlapping area SA. The light reflectivity in the first area A1 is the highest among the light reflectivities on the light exit surface 18c-5. The second areas A2 to the fifth areas A5 are located in the light-source non-overlapping areas SN. The light reflectivities in the second areas A2 that are the closest to the first area A1 are the highest among the light reflectivities in the second areas A2 to the fifth areas A5. The light reflectivities in the fifth areas A5 that are the farthest from the first area A1 and located at the ends of the X dimension of the light guide plate 18-5 are the lowest among the light reflectivities in the second areas A2 to the fifth areas A5. With this configuration, the brightness distribution of the light exiting from the light exit surface 18c-5 can be leveled. Furthermore, the light guide plate 18-5 can be produced by a simple method, that is, by forming the multiple areas A1 to A5 having different light reflectivities. This contributes to a cost reduction.

### Sixth Modification of the First Embodiment

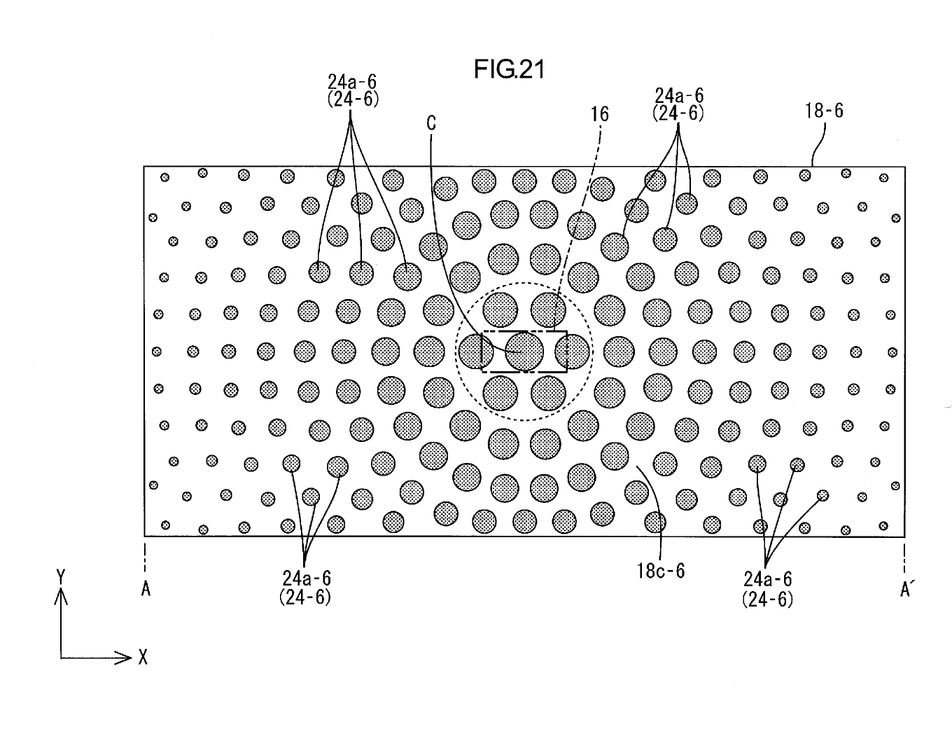

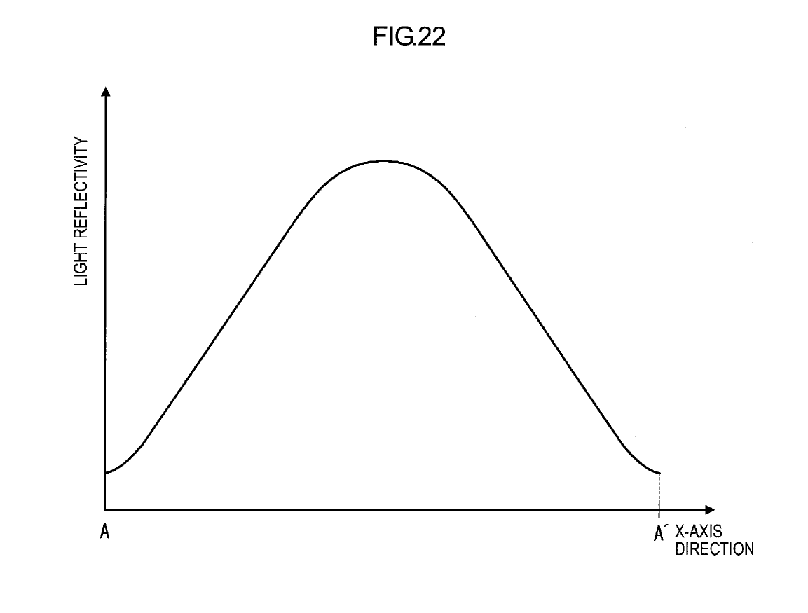

The sixth modification of the first embodiment will be explained with reference to FIGS. 21 and 22. Light reflectors 24-6 having different configurations will be explained.

Each light reflector 24-6 is formed such that the light reflectivity at a light exit surface 18c-6 gradually changes according to the distance from the LED 16. Specifically, the light reflectivity at the light exit surface 18c-6 gradually decreases as the distance from the center C of the LED 16 increases and gradually increases as the distance from the center C decreases. Areas of dots 24a-6 of the light reflector 24-6 located the closest to the center C of the LED 16 and overlapping the center C when viewed in plan are the largest. Areas of the dots 24a-6 gradually decrease as the distance from the center C increases. The areas of the dots 24a-6 located the closest to the ends of the X dimension of the light guide plate 18-6 are the smallest. Namely, the areas of the dots 24a-6 change inversely proportional to the distance from the center C of the LED 16. The overall brightness distribution of the light guide plate 18-6 can be leveled. As a result, the overall brightness distribution of the backlight unit 12 can be leveled.

### Seventh Modification of the First Embodiment

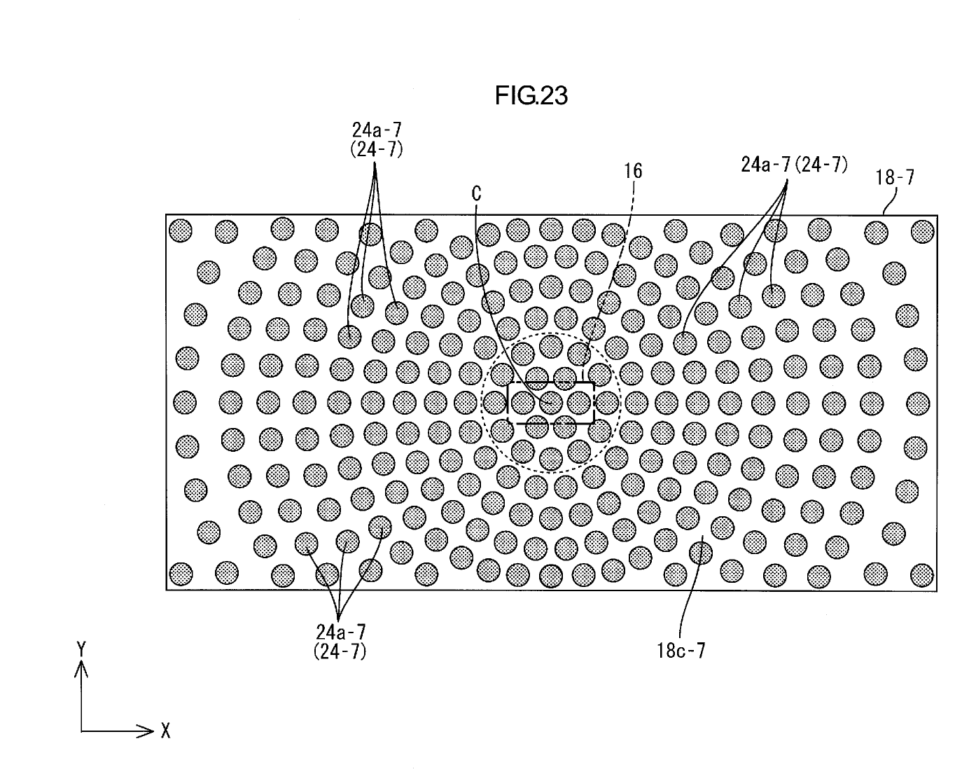

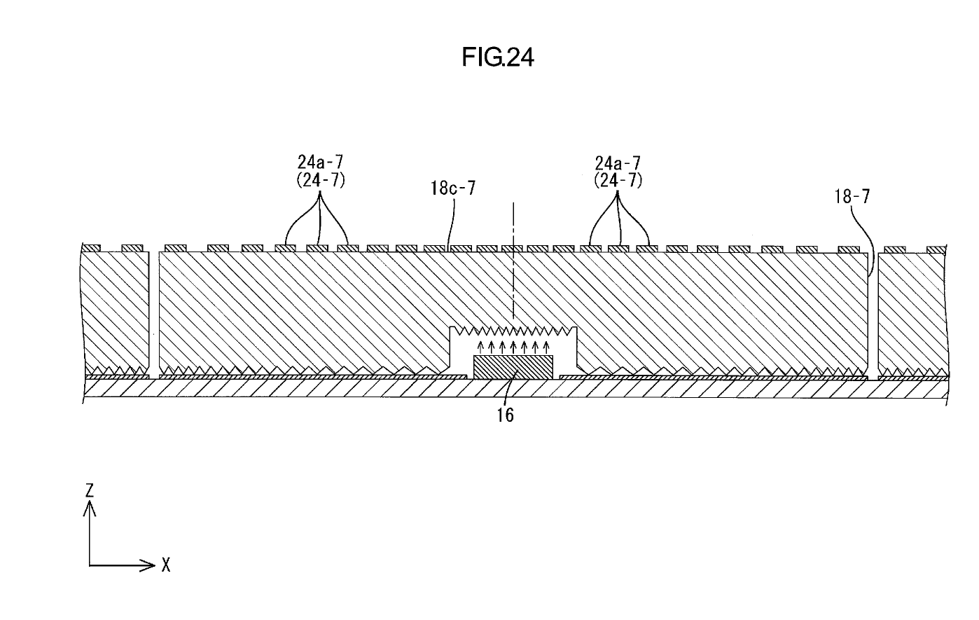

The seventh modification of the first embodiment will be explained with reference to FIGS. 23 and 24. Light reflectors 24-7 having different configurations are used in this modification.

Dots 24a-7 of each light reflector 24-7 are formed such that diameters and areas thereof are substantially the same. The dots 24a-7 are arranged within a light exit surface 18c-7 at intervals and distribution densities different from area to area. Specifically, the dots 24a-7 are arranged such that the intervals become larger and the distribution densities decrease as the distance from the center C of the LED 16 increases. The intervals become smaller and the distribution densities increase as the distance from the center C decreases. By unevenly arranging the dots 24a-7 within the light exit surface 18c-7, the light reflectivities on the light exit surface can be set lower as the distance from the center C increases and higher as the distance from the center C decreases. The diameters and the areas of the dots 24a-7 of this modification are substantially the same. Therefore, print patterns for printing the light reflector 24-7 on the light exit surface 18c-7 can be easily designed.

### Second Embodiment

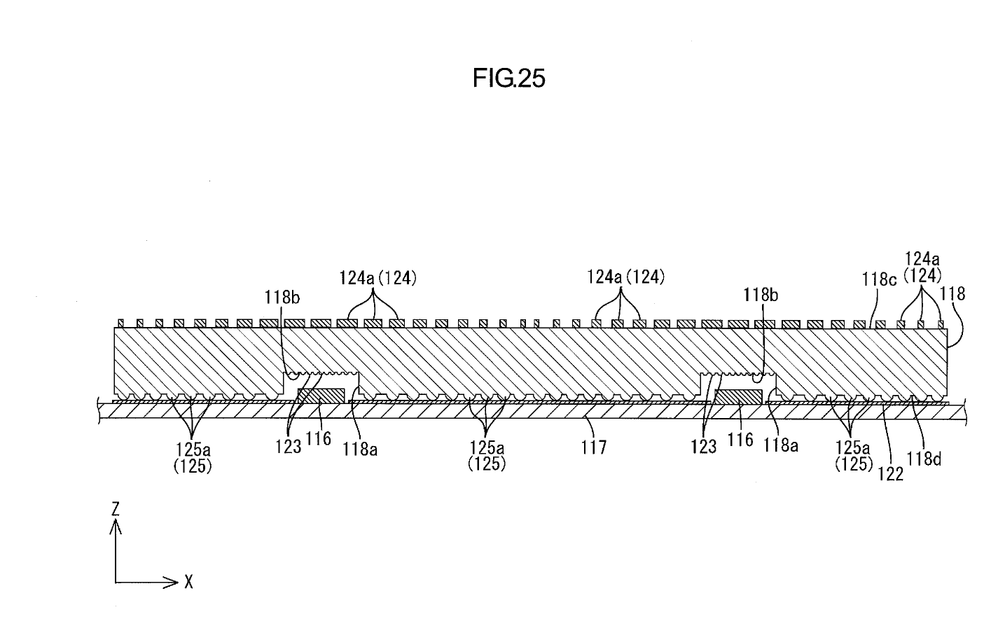

The second embodiment of the present invention will be explained with reference to FIGS. 25 to 29. In this embodiment a plurality of LEDs 116 are provided for each light guide plate 118. Configurations, functions, and effects similar to those of the first embodiment will not be explained.

As illustrated in FIGS. 25, 26, and 28, the light guide plate 118 has four LED holding recesses 118a, two along the X-axis and two along the Y-axis. Specifically, the centers C of the LED holding recesses 118a (corresponding to light entrance surfaces 118b and the light-source overlapping areas SA) are located on respective diagonal lines that connect respective diagonally opposite corners of the light guide plate 118. Four LEDs 116 are mounted on each LED board 117 at locations corresponding to the respective LED holding recesses 118a. When the light guide plate 118 is placed over the LED board 117 from the front side, the LEDs 116 are inserted in the respective LED holding recesses 118a so as to face the respective light entrance surface 118b. A light source unit of this embodiment includes one light guide plate 118 and four LEDs 116.

Next, light reflectors 124 on each light exit surface 118c and second light scattering structures 125 at the reflection sheet attached surfaces 118d to which reflection sheets 122 are attached will be explained in detail. First light scattering structures 123 provided at the light entrance surfaces 118b have the same configurations as those of the first modification of the first embodiment, and will not explained.

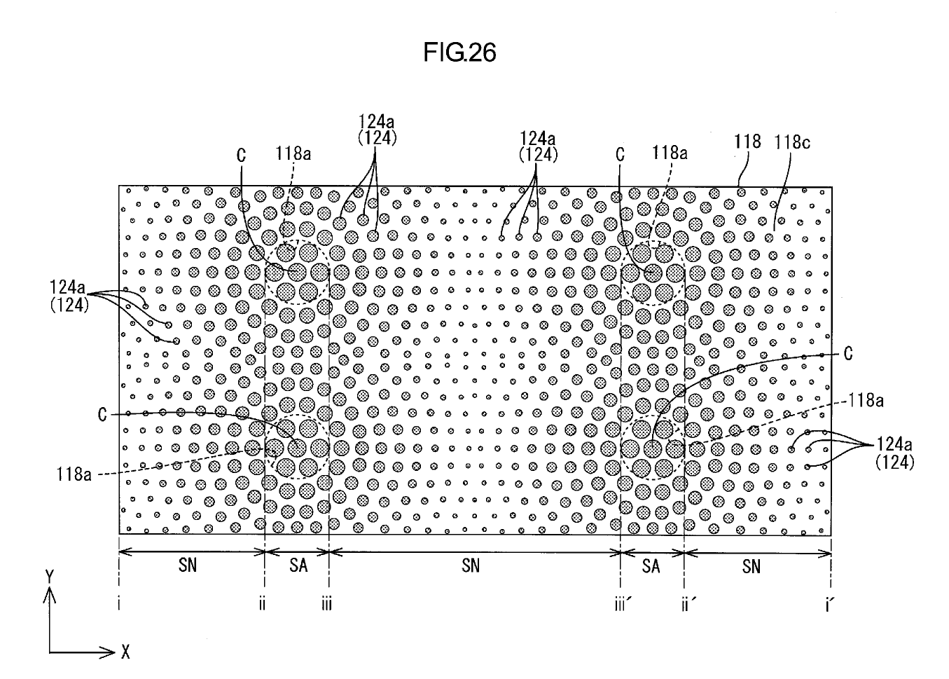

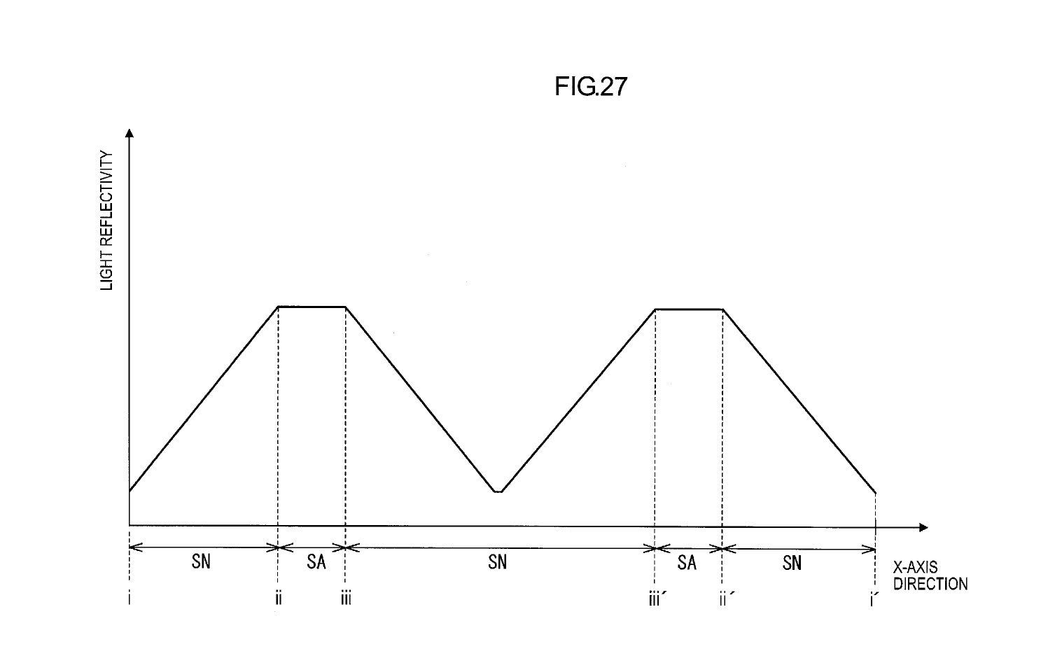

As illustrated in FIG. 26, each light reflector 124 includes a number of dots 124a having round plan-view shapes arranged on the light exit surface 118c. The dots 124a are radially arranged around the centers C of the respective LED holding recesses 118a and the respective LEDs 116. The light reflector 124 is configured such that light reflectivities within the light exit surface 118c differ from area to area. Specifically, the dots 124a are arranged in an entire are of the light exit surface 118a, from the light-source overlapping areas SA to the light-source non-overlapping areas SN, at predetermined distributions. Diameters, or areas, of the dots 124a differ according to locations thereof. The areas of the dots 124a are substantially the same in the light-source overlapping areas SA. The areas of the dots 124a gradually decrease as the distance from the centers C of the respective LED holding recesses 118a and the LEDs 116 increases, and increases as the distance from the centers C decreases. As illustrated in FIG. 27, the light reflectivities on the light exit surface 118c are substantially constant in the light-source overlapping areas SA but decrease as the distance C from the centers C increases in the light-source non-overlapping areas SN and increases as the distance from the centers C decreases. Namely, the light reflectivities gradually change in the light-source non-overlapping areas SN. The light reflectivities on the light exit surface 118c change inversely proportional to the distance from the respective LEDs 116. With this configuration, the distribution of the amount of light exiting from the light exit surface 118c can be evened.

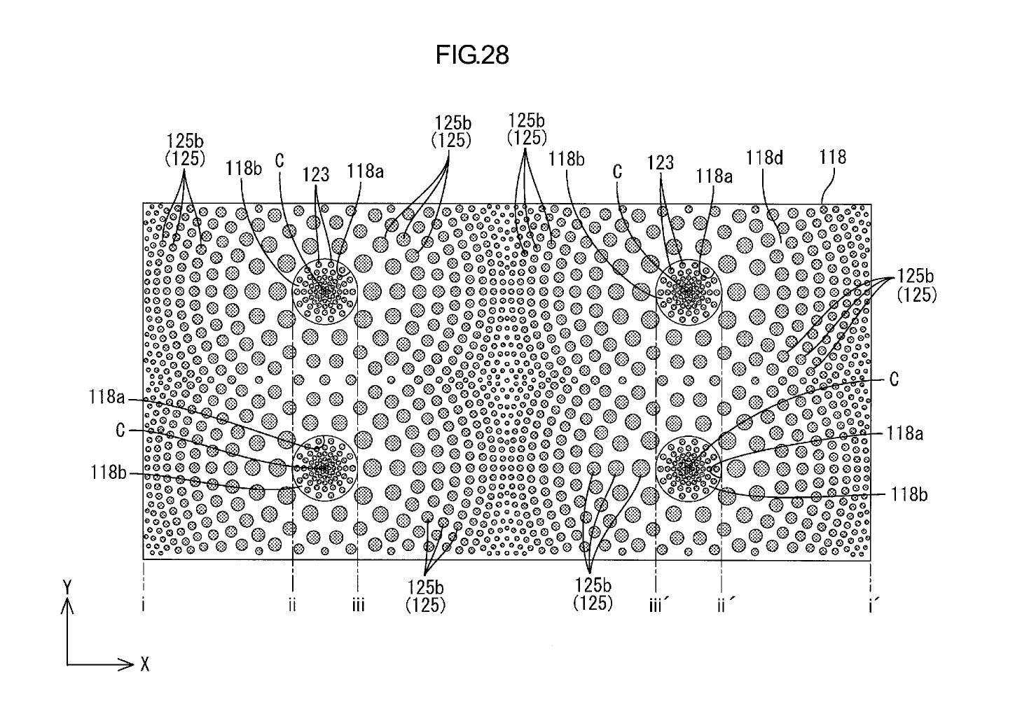

As illustrated in FIG. 28, each second light scattering structure 125 includes a number of round protrusions 125b having round plan-view shapes and arranged on the reflection sheet attached surface 118d, similar to those of the third modification of the first embodiment. Shapes and functions of the round protrusions 125b similar to those of the third modification of the first embodiment will not be explained.

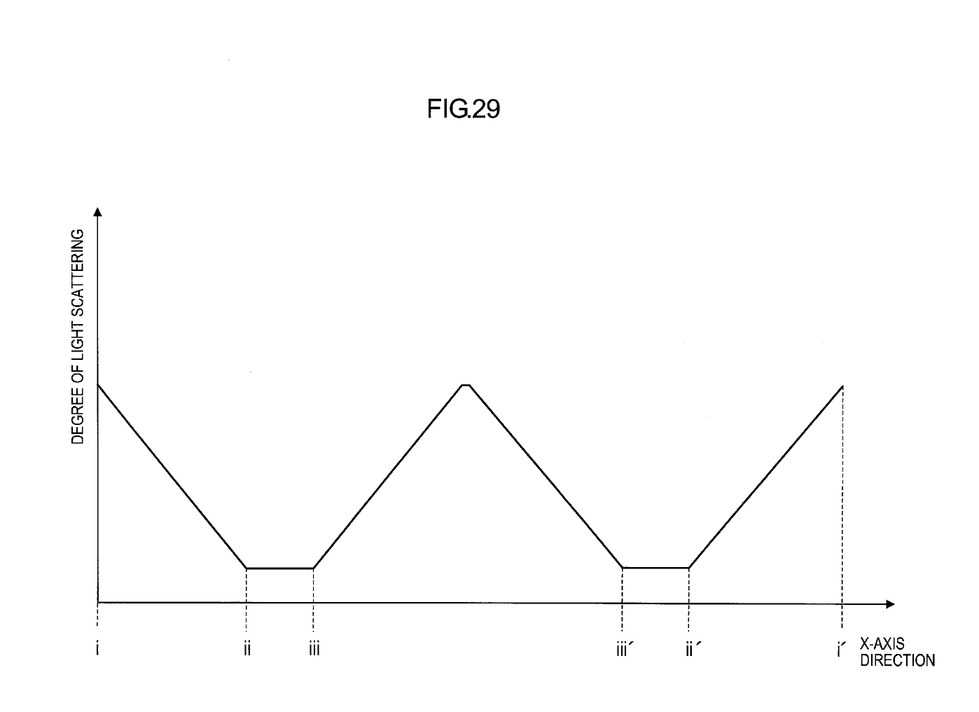

The round protrusions 125b of the second light scattering structure 125 are radially arranged around the centers C of the respective LEDs 116. The diameters and the areas of the round protrusions 125b decrease as the distances from the centers C increase and increase as the distances from the centers C decrease. Intervals between the round protrusions 125b become larger as the distances from the centers C increase and become smaller as the distances from the centers C decrease. The distribution density of the round protrusions 125b on the reflection sheet attached surface 118d (the number of the round protrusions 125b per unit area) becomes higher as the distances from the centers C increase and become lower as the distances from the centers C decrease. As illustrated in FIG. 29, the degrees of light scattering at the reflection sheet attached surface 118d increase as the distance from the centers C increase and decrease as the distance from the centers C decrease. The areas, the intervals, and the distribution densities of the round protrusions 125b gradually change. Furthermore, the degree of light scattering at the reflection sheet attached surface 118d also gradually changes. With this configuration together with the first light scattering structures 123 and the light reflectors 124, the uneven brightness on each light exit surface 118c can be properly reduced.

A plurality of the light guide plates 118 can be arranged parallel to each other similar to the first embodiment. Alternatively, a single light guide plate 118 having a similar plan-view size to that of the liquid crystal panel or the optical member can be arranged inside the chassis.

In this embodiment, a plurality of the LEDs 116 are provided for each light guide plate 118. With this configuration, the brightness can be improved.

### Other Embodiments

The present invention is not limited to the above embodiments explained in the above description. The following embodiments may be included in the technical scope of the present invention, for example.

(1) To set the degree of light scattering at the light entrance surface differently from area to area, the Z dimensions of the annular protrusions (or the annular recesses) or the round protrusions (or the round recesses) of each first light scattering structure may be set differently. The widths of the bases of the annular protrusions or the round protrusions may be also set differently or constant. To set the degree of light scattering at the reflection sheet attached surface differently from area to area, the components of each second light scattering structure may be set similar to those of the first light scattering structure.

(2) To set the degrees of light scattering differently on the light entrance surface, a method other than the method explained in (1) may be used. For example, the intervals between the annular protrusions (or the annular recesses) or the round protrusions (or the round recesses), the distribution densities, the cross-sectional areas, or the surface areas thereof may be set differently according to the locations thereof. The distribution of the degrees of light scattering can be freely designed by using such a method. To set the degrees of light scattering differently on the reflection sheet attached surface, the of the components of each second light scattering structure may be set similar to those of the first light scattering structure.

(3) The shapes of the annular protrusions (or the annular recesses) or the round protrusions (or the round recesses) of the first light scattering structures and the second light scattering structures can be altered as appropriate. For example, the annular protrusions (or the annular recesses) may be provided in U-like shapes. The round protrusions (or the round recesses) may be provided in shapes having triangular cross sections, or in pyramid-like overall shapes (e.g., triangular pyramid-like overall shapes or quadrangular pyramid-like overall shapes).

(4) The distribution of the degrees of light scattering by each first light scattering structure at the light entrance surface may be set similarly to the distribution of the light reflectivities by the light reflector at the light exit surface described in the fifth modification or the sixth modification of the first embodiment. Namely, each first light scattering structure may be formed such that the degrees of light scattering at the light entrance surface change stepwise according to the distance from the center of the LED. Furthermore, each first light scattering structure may be formed such that the degrees of light scattering at the light entrance surface gradually change according to the distance from the center of the LED. The degrees of light scattering of each second light scattering structure can be set similar to the above.

(5) The first light scattering structures may be formed by coating the light entrance surfaces with silica fine powders instead of resign molding. In such a case, the light entrance surfaces are formed as rough surfaces configured to scatter light, and the rough surfaces are the first light scattering structures. Alternatively, the light entrance surfaces may be formed by blasting to form rough surfaces that are the first light scattering structures. The second light scattering structures may be formed by the above methods.

(6) The round protrusions (or the round recesses) of the first light scattering structures and the second light scattering structures are not necessarily to be radially arranged around the centers of the LEDs. The round protrusions may be arranged parallel to each other. In such a case, the round protrusions may be irregularly arranged.

(7) In the above embodiments, each first light scattering structure and each second light scattering structure are provided at about the entire light entrance surface and the entire reflection sheet attached surface, respectively. Moreover, each light reflector is provided at about the entire light exit surface. The first light scattering structure, the second light scattering structure, and the light reflector may be provided at parts of the respective surfaces.

(8) The plan-view shapes of the dots included in each light reflector can be altered as appropriate. Specifically, the shapes may be oval shapes, polygonal shapes including rectangular shapes, or any shapes.

(9) Each light reflector may be formed by a method other than printing. For example, metal evaporation may be used.

(10) In the above embodiments, each light reflector is provided integrally with the light exit surface. However, the light reflector may be provided separately from the light exit surface. Specifically, the light reflector may be formed on a transparent sheet prepared separately from the light guide plate, and the transparent sheet is layered on the light exit surface of the light guide plate. In such a case, the sheet with the light reflector may be attached to the light guide plate with an adhesive or placed on thereon without adhesive.

(11) In the above embodiments, each light reflector is provided in white or silver. However, the light reflector may be provided in a different color.

(12) In the first embodiment, the LEDs and the light guide plates (or light source units) are two-dimensionally arranged inside the chassis. However, they may be one-dimensionally arranged. Specifically, the LEDs and the light guide plates are arranged along the vertical direction or the horizontal direction.

(13) In the second embodiment, the locations and the number of the LEDs on each light guide plate can be altered as appropriate.

(14) In the above embodiments, the air layers are provided as low-refractive-index layers. However, the low-refractive-index layers may be formed by low-refractive-index materials provided in gaps between the light guide plates.

(15) In the above embodiments, each LED includes three LED chips each being configured to emit a single color of light, red, green or blue. However, the LED may include a single LED chip configure to emit a single color of light, blue or violet, and to emit white light by phosphor substances.

(16) In the above embodiments, each LED includes three LED chips, each being configured to emit a single color of light, red, green or blue. However, the LED may include three LED chips, each being configured to emit a single color of light, cyan (C), magenta (M) or yellow (Y).

(17) In the above embodiments, the LEDs are provided as point light sources. However, point light sources other than the LEDs may be used.

(18) In the above embodiment, the LEDs that are point light sources are used as light sources. However, linear light sources, such as cold cathode tubes and hot cathode tubes, may be used as light sources. In such a case, a linear light source may be arranged opposite the light entrance surfaces of a plurality of the light guide plates arranged parallel to each other along the X-axis direction or the Y-axis direction so that the light guide plates are collectively illuminated. The first light scattering structures provided at the light entrance surfaces may include ridges or grooves that linearly extend along an axis of the linear light source. The second light scattering structures may also include ridges or grooves similar to the above.

(19) A planar light source, such as an organic EL, may be used instead of the light sources in the above embodiments, (17) and (18).

(20) The configuration of the optical member can be altered as appropriate from those in the above embodiments.

Specifically, the number of the diffusers, and the number of and the kinds of the optical sheets may be altered as appropriate. Alternatively, a plurality of optical sheets in the same kind may be used.

(21) In the above embodiment, the liquid crystal panel is held in the vertical position with the short-side direction thereof aligned with the vertical direction. However, the liquid crystal panel may be held in the vertical position with the long-side direction thereof aligned with the vertical direction.

(22) In the above embodiments, the TFTs are used as switching components of the liquid crystal display device. However, the technology described herein can be applied to liquid crystal display devices using switching components other than TFTs (e.g., thin film diodes (TFDs)). Furthermore, it can be applied to white-and-black liquid crystal display devices other than the color liquid crystal display device.

(23) In the above embodiments, the liquid crystal display device including the liquid crystal panel as a display component is used. However, the present invention can be applied to display devices including other types of display components.

(24) In the above embodiments, the television receiver including the tuner is used. However, the technology can be applied to a display device without the tuner.

1. A lighting device comprising:
a light source;
a light guide member having a light entrance surface opposite the light source and a light exit surface parallel to the light entrance surface, the light entrance surface through which light enters, and the light exit surface through which the light exits;
a light scattering structure configured to scatter the light and provided at the light entrance surface;
a light reflector configured to reflect the light and provided at the light exit surface.

2. The lighting device according to claim 1, wherein the light scattering structure is configured such that a degree of light scattering within the light entrance surface decreases as a distance from a center of the light source increases.

3. The lighting device according to claim 2, wherein:
the light source is a point light source having a point-like shape when viewed in a plane of the light exit surface; and
the light scattering structure includes any one of a plurality of annular recesses and a plurality of annular protrusions around the center of the point light source.

4. The lighting device according to claim 3, wherein the annular recesses or the annular protrusions are arranged concentrically with each other around the center of the point light source.

5. The lighting device according to claim 2, wherein the light scattering structure includes any one of a plurality of round recesses and a plurality of round protrusions having round shapes when viewed in a plane of the light entrance surface.

6. The lighting device according to claim 5, wherein the round recesses or the round protrusions are formed such that areas thereof increase as the distance from the center of the light source increases.

7. The lighting device according to claim 5, wherein the round recesses or the round protrusions are formed such that a distribution density thereof decreases as the distance from the center of the light source increases.

8. The lighting device according to claim 5, wherein:
the light source is a point light source having a point-like shape when viewed in a plane of the light exit surface; and
the round recesses or the round protrusions are radially arranged around the center of the point light source.

9. The lighting device according to claim 1, wherein the light reflector is provided integrally with the light exit surface.

10. The lighting device according to claim 9, wherein the light reflector is printed on the light exit surface.

11. The lighting device according to claim 1, wherein the light reflector is configured such that a light reflectivity within the light exit surface differs from area to area.

12. The lighting device according to claim 11, wherein the light reflector is arranged at least in a light-source overlapping area of the light exit surface, the light-source overlapping area overlapping the light source.

13. The lighting device according to claim 12, wherein:
the light reflector is arranged also in a light-source non-overlapping area of the light exit surface, the light-source non-overlapping area not overlapping the light source; and
the light reflectivity in the light-source overlapping area is higher than the light reflectivity in the light-source non-overlapping area.

14. The lighting device according to claim 13, wherein the light reflector is formed such that the light reflectivity within the light exit surface decreases as the distance from the light source increases.

15. The lighting device according to claim 14, wherein the light reflector includes a plurality of dots having light reflectivities and point-like shapes when viewed in a plane of the light exit surface.

16. The lighting device according to claim 15, wherein the dots are formed such that areas thereof decrease as the distance from the center of the light source increases.

17. The lighting device according to claim 15, wherein the dots are formed such that a distribution density thereof decreases as the distance from the center of the light source decreases.

18. The lighting device according to claim 15, wherein:
the light source is a point light source having a point-like shape when viewed in a plane of the light exit surface; and
the dots are radially arranged around the center of the point light source.

19. The lighting device according to claim 1, wherein the light reflector has a surface in any one of white and silver.

20. The lighting device according to claim 1, further comprising a reflection sheet arranged on a surface of the light guide member opposite from the light exit surface and configured to reflect the light toward the light exit surface.

21. The lighting device according to claim 20, wherein the surface of the light guide member on which the reflection sheet is arranged has a second light scattering structure configured to scatter the light.

22. The lighting device according to claim 21, wherein the second light scattering structure is configured such that the degree of light scattering within the surface on which the reflection sheet is arranged increases as the distance from the light source increases.

23. The lighting device according to claim 22, wherein:
the light source is a point light source having a point-like shape when viewed in a plane of the light exit surface; and
the second light scattering structure includes any one of a plurality of annular recesses and a plurality of annular protrusions around the point light source.

24. The lighting device according to claim 23, wherein the annular recesses or the annular protrusions are arranged concentrically with each other around the center of the point light source.

25. The lighting device according to claim 22, wherein the second light scattering structure includes any one of a plurality of round recesses and a plurality of round protrusions having point-like shapes when viewed in a plane of the surface on which the reflection sheet is arranged.

26. The lighting device according to claim 25, wherein the round recesses or the round protrusions are formed such that areas thereof decrease as the distance from the light source increases.

27. The lighting device according to claim 25, wherein the round recesses or the round protrusions are formed such that a distribution density thereof increases as the distance from the light source increases.

28. The lighting device according to claim 25, wherein:
the light source is a point light source having a point-like shape when viewed in a plane of the light exit surface; and
the round recesses or the round protrusions are radially arranged around the center of the point light source.

29. The lighting device according to claim 1, wherein:
the light guide member has a light-source holding recess in which the light source is arranged, the light-source holding recess being formed in the surface of the light guide member opposite from the light exit surface; and
the light entrance surface is located at an inner wall of the light-source holding recess.

30. The lighting device according to claim 1, wherein:
the light guide member includes a plurality of light guide members arranged parallel to each other and along at least one of directions along the light exit surface; and
the light source includes a plurality of light sources arranged parallel to each other and along at least one of the directions along the light exit surface.

31. The lighting device according to claim 30, wherein the light guide members and the light sources are two-dimensionally arranged along the light exit surface.

32. The lighting device according to claim 30, further comprising a low-refractive-index layer having a refractive index lower than that of the light guide members and provided between the light guide members.

33. The lighting device according to claim 32, wherein the low-refractive-index layer is an air layer.

34. The lighting device according to claim 1, wherein the light source includes a plurality of light sources relative to the light guide member.

35. The lighting device according to claim 1, wherein the light source is an LED.

36. A display device comprising:
the lighting device according to claim 1; and
a display panel configured to provide display using light from the lighting device.

37. The display device according to claim 36, wherein the display panel is a liquid crystal panel including liquid crystals sealed between a pair of substrates.

38. A television receiver comprising the display device according to claim 36.
